(19) United States
(12) Patent Application Publication
(10) Pub. No.: US 2023/0273974 A1
(43) Pub. Date: Aug. 31, 2023

(54) NETWORK-BASED INFERENCE MACHINE LEARNING MODELS

(71) Applicant: Optum, Inc., Minnetonka, MN (US)

(72) Inventors: Jason R. Robinson, La Jolla, CA (US); Jason Ngo, Sunnyvale, CA (US); Sae Goon Lee, Seattle, WA (US)

(21) Appl. No.: 17/663,966

(22) Filed: May 18, 2022

Related U.S. Application Data
(60) Provisional application No. 63/314,755, filed on Feb. 28, 2022.

(51) Int. Cl. G06K 9/62; G06N 3/08; G06N 3/04

(52) U.S. Cl. CPC G06K 9/6228; G06N 3/08; G06N 3/04

(57) ABSTRACT

Various embodiments of the present invention provide methods, apparatus, systems, computing devices, computing entities, and/or the like for performing predictive data analysis operations using a machine learning framework that comprises a predictive event embedding machine learning model and a network-based inference machine learning model. In some embodiments, a predictive data analysis computing entity performs a sequence of L sequential network updates on an event relationship network data object for a predictive entity to generate a cross-event classification for the predictive entity.

### CROSS-REFERENCES TO RELATED APPLICATION(S)

The present application claims priority to U.S. Provisional Patent Application No. 63/314,755, filed on Feb. 28, 2022, which is incorporated by reference herein in its entirety.

### BACKGROUND

Various embodiments of the present invention address technical challenges related to performing predictive data analysis and provide solutions to address the efficiency and reliability shortcomings of existing predictive data analysis solutions.

### BRIEF SUMMARY

In general, various embodiments of the present invention provide methods, apparatus, systems, computing devices, computing entities, and/or the like for performing predictive data analysis operations using a machine learning framework that comprises a predictive event embedding machine learning model and a network-based inference machine learning model. In some embodiments, a predictive data analysis computing entity performs a sequence of L sequential network updates on an event relationship network data object for a predictive entity to generate a cross-event classification for the predictive entity.

In accordance with one aspect, a method is provided. In one embodiment, the method comprises: identifying a plurality of predictive events associated with a predictive entity; for each predictive event, generating, using an predictive event embedding machine learning model and based at least in part on the predictive event, a predictive event embedding for the predictive event; generating an event relationship network data object for the predictive entity, wherein the event relationship network data object describes: (i) a plurality of predictive event embeddings each associated with a respective predictive event, and (ii) one or more event relationship links each associated with an predictive event pair comprising a first predictive event and a second predictive event, and (iii) one or more relationship embeddings each associated with a respective event relationship link; generating, using a network-based inference machine learning model and based at least in part on the event relationship network data object: (i) a final predictive event embedding for each predictive event, and (ii) a final relationship embedding for each event relationship link, wherein: (a) the network-based inference machine learning model comprises L sequential network update layers, (b) each sequential network update layer is configured to update the event relationship network data object based at least in part on a trained parameter set associated with the sequential network update layer, and (c) each final predictive event embedding and each final relationship embedding is determined based at least in part on a final sequential network update layer as generated by the final sequential network update layer; generating a cross-event classification for the predictive entity based at least in part on at least one of each final predictive event embedding and each final relationship embedding; and performing one or more prediction-based actions based at least in part on the cross-event classification.

In accordance with another aspect, an apparatus comprising at least one processor and at least one memory including computer program code is provided. In one embodiment, the at least one memory and the computer program code may be configured to, with the processor, cause the apparatus to: identify a plurality of predictive events associated with a predictive entity; for each predictive event, generate, using an predictive event embedding machine learning model and based at least in part on the predictive event, a predictive event embedding for the predictive event; generating an event relationship network data object for the predictive entity, wherein the event relationship network data object describes: (i) a plurality of predictive event embeddings each associated with a respective predictive event, and (ii) one or more event relationship links each associated with an predictive event pair comprising a first predictive event and a second predictive event, and (iii) one or more relationship embeddings each associated with a respective event relationship link; generate, using a network-based inference machine learning model and based at least in part on the event relationship network data object: (i) a final predictive event embedding for each predictive event, and (ii) a final relationship embedding for each event relationship link, wherein: (a) the network-based inference machine learning model comprises L sequential network update layers, (b) each sequential network update layer is configured to update the event relationship network data object based at least in part on a trained parameter set associated with the sequential network update layer, and (c) each final predictive event embedding and each final relationship embedding is determined based at least in part on a final sequential network update layer as generated by the final sequential network update layer; generate a cross-event classification for the predictive entity based at least in part on at least one of each final predictive event embedding and each final relationship embedding; and perform one or more prediction-based actions based at least in part on the cross-event classification.

In accordance with yet another aspect, a computer program product is provided. The computer program product may comprise at least one computer-readable storage medium having computer-readable program code portions stored therein, the computer-readable program code portions comprising executable portions configured to: identify a plurality of predictive events associated with a predictive entity; for each predictive event, generate, using an predictive event embedding machine learning model and based at least in part on the predictive event, a predictive event embedding for the predictive event; generating an event relationship network data object for the predictive entity, wherein the event relationship network data object describes: (i) a plurality of predictive event embeddings each associated with a respective predictive event, and (ii) one or more event relationship links each associated with an predictive event pair comprising a first predictive event and a second predictive event, and (iii) one or more relationship embeddings each associated with a respective event relationship link; generate, using a network-based inference machine learning model and based at least in part on the event relationship network data object: (i) a final predictive event embedding for each predictive event, and (ii) a final relationship embedding for each event relationship link, wherein: (a) the network-based inference machine learning model comprises L sequential network update layers, (b) each sequential network update layer is configured to update the event relationship network data object based at least in part on a trained parameter set associated with the sequential network update layer, and (c) each final predictive event embedding and each final relationship embedding is determined based at least in part on a final sequential network update layer as generated by the final sequential network update layer; generate a cross-event classification for the predictive entity based at least in part on at least one of each final predictive event embedding and each final relationship embedding; and perform one or more prediction-based actions based at least in part on the cross-event classification.

### BRIEF DESCRIPTION OF THE DRAWINGS

Having thus described the invention in general terms, reference will now be made to the accompanying drawings, which are not necessarily drawn to scale, and wherein:

FIG. 1 provides an exemplary overview of an architecture that can be used to practice embodiments of the present invention.

FIG. 2 provides an example predictive data analysis computing entity in accordance with some embodiments discussed herein.

FIG. 3 provides an example client computing entity in accordance with some embodiments discussed herein.

FIG. 4 is a flowchart diagram of an example process for generating a cross-event classification for a predictive entity in accordance with some embodiments discussed herein.

FIG. 5 provides an operational example of a set of predictive events associated with a predictive entity that corresponds to a customer-initiated airline complaint in accordance with some embodiments discussed herein.

FIG. 6 provides an operational example of a set of predictive events associated with a predictive entity that corresponds to a medical visit in accordance with some embodiments discussed herein.

FIG. 7 provides an operational example of generating predictive event embeddings for a predictive entity that is associated with two predictive events in accordance with some embodiments discussed herein.

FIG. 8 provides an operational example of an event relationship network data object as initially generated in accordance with some embodiments discussed herein.

FIGS. 9A-9D provide an operational example of sequentially processing an event relationship network data object using L sequential network update layers of a network-based inference machine learning model to generate a final relationship network data object in accordance with some embodiments discussed herein.

FIGS. 10-11 provide operational examples of generating per-event classifications for a set of four predictive events in accordance with some embodiments discussed herein.

FIG. 12 provides an operational example of a prediction output user interface in accordance with some embodiments discussed herein.

### DETAILED DESCRIPTION

Various embodiments of the present invention now will be described more fully hereinafter with reference to the accompanying drawings, in which some, but not all, embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout. Moreover, while certain embodiments of the present invention are described with reference to predictive data analysis, one of ordinary skill in the art will recognize that the disclosed concepts can be used to perform other types of data analysis.

### I. Overview and Technical Improvements

Various embodiments of the present invention improve computational efficiency of generating cross-event classifications for predictive entities that are associated with a large number of predictive events by disclosing techniques that generate a cross-event predictive classification for a predictive entity via processing an event relationship network data object associated with the predictive entity using a set of sequential network updates associated with the layers of a network-based inference machine learning model. Given a predictive entity that is associated with E predictive events, a naïve solution to generating a cross-event classification for the predictive entity based at least in part on the E predictive events comprises processing each of the E predictive events using a trained classification machine learning model. If each inference of the trained classification machine learning model involves an average of F₁ floating point operations per second (FLOPS), because E inferences need to be performed in accordance with the naïve solution, then this means that generating a cross-event classification for the predictive entity based at least in part on the E predictive events associated with the predictive entity and in accordance with the naïve approach has a computational complexity of O(E*F₁). In contrast, various embodiments of the present invention generate an event relationship network data object that describes embeddings for all of the E predictive events and process the event relationship network data object using a singular predictive inference of a network-based inference machine learning model to generate the cross-event classification for the corresponding predictive entity. This means that, if each inference of the network-based inference machine learning model involves an average of F₂ FLOPS, because only a single inference of the network-based inference machine learning model is performed in accordance with various embodiments of the present invention, then this means that generating a cross-event classification for the predictive entity performed in accordance with various embodiments of the present invention has a computational complexity of O(F₂). Moreover, because in at least some embodiments the operations of the network-based inference machine learning model comprise a sequence of linear combination operations (e.g., a sequence of matrix multiplication operations), it is expected that F₂=<F₁ (and most likely F₂<F₁), which means that, for E>1, O(F₂) is guaranteed to be less than O(E*F₁), and the performance gap between the two computational complexities increases as the value of E increases. Accordingly, by reducing the computational complexity of generating a cross-event classification for a predictive entity that is associated with two or more predictive events, and by reducing the number of computer processor operations needed to generate a cross-event classification for a predictive entity that is associated with two or more predictive events, various embodiments of the present invention improve computational efficiency of generating cross-event classifications in relation to predictive entities that are associated with a large number of predictive events.

Moreover, various embodiments of the present invention make important technical contributions to improving resource-usage efficiency of post-prediction systems by using per-event classifications to set the number of allowed computing entities used by the noted post-prediction systems. For example, in some embodiments, a predictive data analysis computing entity determines E per-event classifications for E predictive events of a predictive entity based at least in part on the event relationship network data object with the predictive entity. Then, the count of predictive events that are associated with affirmative per-event classifications, along with a resource utilization ratio for each predictive event, can be used to predict a predicted number of computing entities needed to perform post-prediction processing operations (e.g., automated reason for visit investigation operations) with respect to the E predictive events. For example, in some embodiments, the number of computing entities needed to perform post-prediction processing operations (e.g., automated investigation operations) with respect to the E predictive events can be determined based at least in part on the output of the equation: R=ceil(Σₖ^{k=K} urₖ), where R is the predicted number of computing entities needed to perform post-prediction processing operations with respect to the E predictive events, ceil(.) is a ceiling function that returns the closest integer that is greater than or equal to the value provided as the input parameter of the ceiling function, k is an index variable that iterates over K predictive events among the E predictive events that are associated with affirmative investigative classifications, and urₖ is the estimated resource utilization ratio for a kth predictive event that may be determined based at least in part on a size of input data associated with the kth predictive event. In some embodiments, once R is generated, the predictive data analysis computing entity can use R to perform operational load balancing for a server system that is configured to perform post-prediction processing operations (e.g., automated investigation operations) with respect to the E predictive events. This may be done by allocating computing entities to the post-prediction processing operations if the number of currently-allocated computing entities is below R, and deallocating currently-allocated computing entities if the number of currently-allocated computing entities is above R.

An exemplary application of various embodiments of the present invention relates to predicting or identifying likely motivating factors for a given event or action. In an illustrative example, given a set of facts relating to a patient and a patient's visit to a healthcare provider, various embodiments of the present invention are directed to determining which of the set of facts were most motivating for the patient to visit the healthcare provider. Various embodiments of the present invention identify motivating facts or factors through organizing representations of each fact in a graph structure and optimizing the graph structure using a graph neural network. A key benefit of various embodiments of the present invention is improved efficiency in healthcare billing, as Reason for Visit codes in healthcare claims can be completed automatically with accuracy. Various embodiments of the present invention can be further applied by business entities to identify key consumer-driving areas for improvement or investment, for example.

Various embodiments of the present invention are directed to identifying motivating facts that caused a particular event or action. Aspects of various embodiments of the present invention may begin with a set of facts that are related to the particular event or action, and the facts may be input by a user, collected from a database and/or a profile, and/or the like. Within the set of facts may be one or more facts that specifically caused the particular event or action to occur. In accordance with various embodiments of the present invention, the facts are relied upon as true historical data that preceded the event or action. In various examples, facts of different data types or modalities may be obtained and predicted to be a motivating fact.

In some embodiments, in order to fairly evaluate the facts, or historical data entries, related to the event or action in question, the historical data entries are embedded; that is, representations are generated for the historical data entries. Different embedding models may be used embed historical data entries of different data types. The embedding models may be trained to generate the representations during a training phase, in which motivating facts are specifically labeled within a set of facts for a particular event or action. Thus, the embedding models may be trained in a supervised manner.

The representations may then be organized into a graph data structure, which may be understood as a fact network. Nodes of the fact network are embodied by the representations output by the embedding models. The fact network may be fully connected with the edge weights initialized to a maximum value (e.g., 1.0) to represent the initial assumption that the facts are all related and of equal importance. The graph data structure, or fact network, may then be passed through a graph neural network machine learning model (e.g., a graph convolutional neural network) that is configured and trained to iteratively optimize the graph data structure. In particular, the graph neural network machine learning model can optimize both the nodal representations as well as the edge weights. The graph neural network machine learning model can be trained in a supervised manner. As discussed above, training data may include a set of facts labelled according to whether each fact is motivating or not. Thus, with such ground-truth labels, each layer of the graph neural network machine learning model learns motivating features found in motivating facts for a given event or action. In various examples, the graph neural network machine learning model and the embedding machine learning models may be trained simultaneously with the same training data. After passing through the graph neural network machine learning model, the representations of historical data entries that define the nodes of the graph data structure are modified into a reduced form.

In some embodiments, equipped with which historical data entries are predicted to be motivating for the particular event or action, various actions can be performed. For instance, such predictions may be used by business entities to correct certain operations, by healthcare entities to automatically complete visit reason information, and/or the like. The predictions may also be displayed or provided to a user, who can verify the prediction and use the prediction as further training data.

### II. Definitions

The term “predictive entity” may refer to a data construct that describes a real-world entity and/or a virtual entity (e.g., a service delivery session, such as a medical visit) with respect to which one or more predictive data analysis operations are performed. For example, the predictive entity may describe a medical visit, and the noted predictive data analysis operations may be configured to describe a reason for visit (RFV) for the medical visit. As another example, the predictive entity may describe a transactional event such as the return of a product, and the noted predictive data analysis operations may be configured to describe a return for the noted transactional event such as the reason for return of the product. As a further example, the predictive entity may describe a system failure for a computer system, and the noted predictive data analysis operations may be configured to describe a reason for the system failure.

The term “predictive event” may refer to a data construct that describes a recorded state of one or more monitored systems that are determined to be related to a predictive entity. For example, when the predictive entity is a medical visit, the predictive events associated with the predictive entity may include at least a subset of medical codes (e.g., diagnosis codes, procedure codes, pharmacy codes, and/or the like) and/or at least a subset of medical conditions associated with a corresponding patient identifier for the medical visit, such as the medical codes of the noted patient identifier that are associated with medical visits whose respective occurrence/recordation timestamps fall within a threshold proximity of a timestamp associated with the medical visit. As another example, when the predictive entity is a system failure of a particular software system, the predictive events associated with the predictive entity may include at least a subset of software alert data objects that are captured by a software monitoring framework associated with the particular software system. In some embodiments, given a set of monitored systems associated with a predictive entity, the predictive events for the predictive entity include at least a subset of the predictive events generated by the set of monitored systems whose timestamps are within a threshold proximity of a timestamp associated with the predictive entity, such as a subset of the predictive events generated by the set of monitored systems whose timestamps are within the threshold proximity of the timestamp associated with the predictive entity and whose associated user identifiers correspond to a user identifier of the predictive entity.

The term “predictive event embedding” may refer to a data construct that describes a fixed-length representation of a corresponding predictive event, where an initial value of the predictive event embedding may be generated by processing input data associated with the corresponding predictive event using a predictive event embedding machine learning model. For example, the initial value for the predictive event embedding for an image-based predictive event describing an image may describe a fixed-length representation of the image that is generated by processing the image using an image embedding component of the predictive event embedding machine learning model, such as an image embedding component that comprises a two-dimensional convolutional neural network. As another example, the initial value for the predictive event embedding for a text-based predictive event describing a text document data object may describe a fixed-length representation of the text document data object that is generated by processing the text document data object using a text embedding component of the predictive event embedding machine learning model, such as a text embedding component that uses one or more attention mechanisms (e.g., one or more self-attention mechanisms, such as one or more bidirectional self-attention mechanisms). As a further example, the initial value for the predictive event for a categorical predictive event describing a categorical feature may describe a fixed-length representation of the categorical feature that is generated by processing the categorical feature using a categorical feature embedding component of the predictive event embedding machine learning model, such as a categorical feature embedding component that uses a one-hot-encoding mechanism. As described above, in some embodiments, each predictive event embedding has a uniform size, e.g., comprises N₀ values. For example, in some embodiments, given a predictive entity that is associated with E predictive events, E predictive event embeddings are generated, where each of the E predictive event embeddings comprises No values. In some embodiments, the predictive event embedding for a particular predictive event having a particular data format is generated by processing data associated with the particular predictive event using an embedding component of a predictive event machine learning model that is associated with the particular data format.

The term “predictive event embedding machine learning model” may refer to a data construct that describes parameters, hyperparameters, and/or defined operations of a machine learning model, where the machine learning model is configured to process a predictive event to generate a predictive event embedding for the predictive event. As described above, given E predictive events that are associated with F data formats, the predictive event embedding machine learning model may comprise F embedding components, where each embedding component is configured to process those predictive events having a particular data format to generate corresponding predictive event embeddings. For example, the predictive event embedding machine learning model may comprise at least one of the following: (i) an image embedding component that is configured to process the image associated with an image-based predictive event to generate the predictive event embedding for the noted image-based predictive event, (ii) a text embedding component that is configured to process the text data object data object associated with a text-based predictive event to generate a predictive event embedding for the text-based predictive event, or (iii) a categorical feature embedding component that is configured to process the categorical feature associated with a categorical predictive event to generate a predictive event embedding for the categorical predictive event. In some embodiments, when a predictive event embedding machine learning model comprises F embedding components, the inputs to each embedding component may have a different dimensionality and/or size, while the outputs of the F embedding components all have a uniform size, e.g., all comprise N₀ values. For example, the inputs to an image embedding component of the predictive event embedding machine learning model may include a matrix describing pixel values of an input image. As another example, the inputs to a text embedding component of the predictive event embedding machine learning model may include T vectors each corresponding to an input representation (e.g., a one-hot-encoded representation, a Word2Vec-generated representation, and/or the like) of a token/word of an input text document data object. As a further example, the inputs to a categorical feature embedding component of the predictive event embedding machine learning model may include a vector describing a one-hot-encoded representation of an input categorical feature.

The term “event relationship network data object” may refer to a data construct that describes a network corresponding to a fully-connected graph (i.e., a graph where each node pair is connected via a link/edge), where each node of the network corresponds to a predictive event of a particular predictive entity and describes the predictive event embedding for the predictive event that is associated with the node. In some embodiments, the event relationship network data object describes a set of links between the nodes of the event relationship network data object, where each link is associated with a node pair corresponding to a predictive event pair and describes a relationship embedding for an event relationship link between the predictive event pair that corresponds to the node pair. For example, given a predictive entity that is associated with E predictive entities, the event relationship network data object may comprise E nodes and

$$R = \frac{E !}{2 ( E - 2 ) !}$$

links/edges, where each node describes the predictive event embedding for a corresponding predictive event, and each link/edge is an event relationship link between a first predictive event and a second predictive event which describes a relationship embedding for the event relationship link. In some embodiments, the event relationship graph data object for a predictive entity is described by two two-dimensional data objects (e.g., two two-dimensional array data objects, two two-dimensional data objects each describing a two-dimensional matrix, and/or the like): an event-related two-dimensional data object (e.g., an event-related matrix data object) that describes predictive event embeddings for the predictive events associated with the predictive entity, and a relationship-related two-dimensional data object (e.g., a relationship-related matrix data object) that describes relationship embeddings for the event relationship links associated with the predictive entity. This may mean that, when initially generated, the event relationship graph data object may comprise: (i) an event-related two-dimensional data object that is an E*N₀ data object, where E describes the number of predictive events of the predictive entity, and N₀ describes the uniform size of each of the E initially-generated predictive event embeddings for the E predictive events of the predictive entity; and (ii) a relationship-related two-dimensional data object that is an R*K₀ two-dimensional data object, where R describes the number of event relationship links of the predictive entity and K₀ may describe the uniform size of each of the R initially-generated relationship embeddings for the R event relationship links of the predictive entity.

The term “relationship embedding” may refer to a data construct that describes a fixed-size representation of an event relationship link between a first predictive event and a second predictive event. In some embodiments, given a predictive entity that is associated with R event relationship links, the R relationship embeddings for the R event relationship links are initialized using an initialization strategy, such as: (i) an initialization strategy that assigns a common vector (e.g., a [1.0] vector) to each of the R relationship embeddings, (ii) an initialization strategy that assigns a vector [x] vector to each relationship embedding, where x is a ground-truth relationship significance measure for the event relationship link that is associated with the relationship embedding, and (iii) an initialization strategy that assigns a vector [x] vector to each relationship embedding, where x is an inferred relationship significance measure for the event relationship link that is associated with the relationship embedding. In some embodiments, the inferred relationship significance measure for an event relationship link between a first predictive entity and a second predictive entity is generated based at least in part on the output of processing the first predictive entity and the second predictive entity using a relationship embedding machine learning model. In some embodiments, the inferred relationship significance measure for an event relationship link between a first predictive entity and a second predictive entity is generated based at least in part on the output of processing the predictive event embedding for the first predictive entity and the predictive event embedding for second predictive entity using a relationship embedding machine learning model.

The term “final predictive event embedding” may refer to a data construct that describes the predictive event embedding for a corresponding predictive event after an initially-generated predictive event embedding for the corresponding predictive event has undergone L updates using a network-based inference machine learning model. In some embodiments, a predictive data analysis computing entity performs, via the operations corresponding to the L sequential network update layers of a network-based inference machine learning model, L sequential network updates on the event relationship network data object. During each sequential network update performed by a particular sequential network update layer of the network-based inference machine learning model, a latest state of the event relationship network data object is updated via processing the event relationship network data object based at least in part on the trained parameters of the particular sequential network update layer. This means that, after being processed by the L sequential network update layers of the network-based inference machine learning model, the event relationship network data object still has the same network architecture describing E event nodes and R event relationship links, but that the E predictive event embeddings and the R relationship embeddings have each gone through L transformations. In some of the noted embodiments, a final predictive event embedding is a predictive event embedding described by an event relationship network data object that is generated after L transformations of the event relationship network data object by the L sequential network update layers of the network-based inference machine learning model, while a final relationship embedding is a relationship embedding described by an event relationship network data object that is generated after L transformations of the event relationship network data object by the L sequential network update layers of the network-based inference machine learning model.

The term “final relationship embedding” may refer to a data construct that describes the relationship embedding for a corresponding event relationship link after an initially-generated relationship embedding for the corresponding event relationship link has undergone L updates using a network-based inference machine learning model. In some embodiments, a predictive data analysis computing entity performs, via the operations corresponding to the L sequential network update layers of a network-based inference machine learning model, L sequential network updates on the event relationship network data object. During each sequential network update performed by a particular sequential network update layer of the network-based inference machine learning model, a latest state of the event relationship network data object is updated via processing the event relationship network data object based at least in part on the trained parameters of the particular sequential network update layer. This means that, after being processed by the L sequential network update layers of the network-based inference machine learning model, the event relationship network data object still has the same network architecture describing E event nodes and R event relationship links, but that the E predictive event embeddings and the R relationship embeddings have each gone through L transformations. In some of the noted embodiments, a final predictive event embedding is a predictive event embedding described by an event relationship network data object that is generated after L transformations of the event relationship network data object by the L sequential network update layers of the network-based inference machine learning model, while a final relationship embedding is a relationship embedding described by an event relationship network data object that is generated after L transformations of the event relationship network data object by the L sequential network update layers of the network-based inference machine learning model.

The term “network-based inference machine learning model” may refer to a data construct that describes parameters, hyperparameters, and/or defined parameters of a machine learning model that is configured to generate an updated event relationship network data object based at least in part on the output of processing an initially-generated event relationship network data object via L sequential network updates. In some embodiments, a network-based inference machine learning model is configured to perform L sequential updates on an event relationship network data object for a predictive entity. During each sequential update that is performed by a respective sequential network update layer of the network-based inference machine learning model, at least one of the predictive event embeddings and/or at least one of the relationship embeddings described by the event relationship network data object may be updated based at least in part on one or more trained parameters associated with the respective network sequential update layer. In some embodiments, each ith sequential update layer: (i) is associated with an ith layer event-related parameter data object that is Nᵢ₋₁*Nᵢ two-dimensional event-related parameter data object describing Nᵢ₋₁*Nᵢ event-related trained parameter values, (ii) is associated with an ith layer relationship-related parameter data object that is Kᵢ₋₁*Kᵢ two-dimensional relationship-related parameter data object describing Kᵢ₋₁*Kᵢ event-related trained parameter values, and (iii) is configured to: (a) identify an input event relationship network data object that describes an input E*Nᵢ₋₁ event-related two-dimensional data object and an input R*Kᵢ₋₁ relationship-related two-dimensional data object, (b) multiply the input E*Nᵢ₋₁ event-related two-dimensional data object with the ith layer event-related parameter data object to generate an updated E*Nᵢ event-related two-dimensional data object, (c) multiply the input R*Kᵢ₋₁ relationship-related two-dimensional data object with the ith layer relationship-related parameter data object to generate an updated R*Kᵢ relationship-related two-dimensional data object, and (d) generate an updated event relationship network data object that comprises the updated E*Nᵢ event-related two-dimensional data object and the updated R*Kᵢ relationship-related two-dimensional data object. In some embodiments, if the ith sequential update layer is an initial sequential update layer, then the input event relationship network data object for the ith sequential update layer is the originally-generated event relationship network data object. In some embodiments, if the ith sequential update layer is a non-initial sequential update layer, then the input event relationship network data object for the ith sequential update layer is the updated event relationship network data object generated by an immediately preceding (i.e., an (i−1)th) sequential update layer. In some embodiments, if the ith sequential update layer is a non-final sequential update layer, then the updated event relationship network data object generated by the ith sequential update layer is provided as the input event relationship network data object to an immediately succeeding (i.e., an (i+1)th) sequential update layer. In some embodiments, if the ith sequential update layer is a final sequential update layer, then the updated event relationship network data object generated by the ith sequential update layer is used to generate final predictive event embeddings and final relationship embeddings. In some embodiments, each ith sequential update layer is associated with at least two hyperparameters: an Nᵢ hyperparameter that describes the size of the updated predictive event embeddings generated by the ith sequential update layer, and a Kᵢ hyperparameter that describes the size of the updated relationship embeddings generated by the ith sequential update layer.

The term “cross-event classification” may refer to a data construct that describes the output of a predictive inference performed with respect to a corresponding predictive entity based at least in part on a set of predictive events associated with the predictive event. For example, the cross-event classification for a predictive entity that is associated with a medical visit may describe an inferred/predicted RFV for the medical visit. As another example, the cross-event classification for a predictive entity that is associated with a transactional activity may describe an inferred/predictive reason for the transactional activity. As a further example, the cross-event classification for a predictive entity that is associated with a computer system failure may describe an inferred/predictive cause of the noted computer system failure. In some embodiments, given a predictive entity that is associated with E predictive events, the cross-event classification for the predictive entity is determined based at least in part on E per-event classifications for the E predictive events. In some of the noted embodiments, each per-event classification for a predictive event describes whether the predictive event is predicted to be a significant reason for the predictive entity. For example, when the predictive entity describes a medical visit, and when the medical visit is associated with a set of medical conditions corresponding to a set of predictive events for the predictive entity, each predictive event is associated with a per-event classification that describes whether the corresponding medical condition is predicted to be an RFV for the medical visit. In some embodiments, when a predictive event is predicted to be a significant reason for the predictive entity, the predictive event is associated with an affirmative per-event classification. In some embodiments, when a predictive event is predicted to not be a significant reason for the predictive entity, the predictive event is associated with a negative per-event classification. In some embodiments, the cross-event classification for a predictive entity describes at least one of the following: (i) which predictive events of the predictive entity are associated with affirmative per-event classifications, or (ii) which predictive events of the predictive entity are associated with negative per-event classifications.

The term “per-event classification” may refer to a data construct that describes a predicted determination about contribution of a corresponding predictive event to a predictive entity. For example, the per-event classification for a predictive event may describe whether the predictive event is predicted to be a significant reason for the predictive entity. As another example, the per-event classification for a predictive event may describe a selected predictive event significance classification for the predictive entity that is selected from a group of defined predictive event classifications for the predictive entity. In an exemplary embodiment, the group of defined predictive event classifications for a predictive entity may comprise a positive predictive event classification that is assigned to a predictive event for a predictive entity if the predictive event is predicted to have a positive correlation with the predictive entity, a negative predictive event classification that is assigned to a predictive event for a predictive entity if the predictive event is predicted to have a negative correlation with the predictive entity, and a neutral predictive event classification that is assigned to a predictive event for the predictive entity if the predictive event is predicted to have no correlation with the predictive entity. In some embodiments, the per-event classification for a particular predictive event is generated based at least in part on whether an ith value of the final predictive event embedding for the particular predictive event satisfies (e.g., exceeds) a threshold value defined based at least in part on a jth value of the final predictive event embedding for the particular predictive event (e.g., whether the ith value of the final predictive event embedding for the particular predictive event exceeds the jth value of the final predictive event embedding for the particular predictive event). In some embodiments, the per-event classification for a particular predictive event describes a selected predictive event significance classification for the particular predictive event, where the selected predictive event significance classification is determined based at least in part on a maximal value position indicator for a maximal value of the final predictive event embedding of the particular predictive event that describes the position of the largest value of the final predictive event embedding.

### III. Computer Program Products, Methods, and Computing Entities

Embodiments of the present invention may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations. Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### IV. Exemplary System Architecture

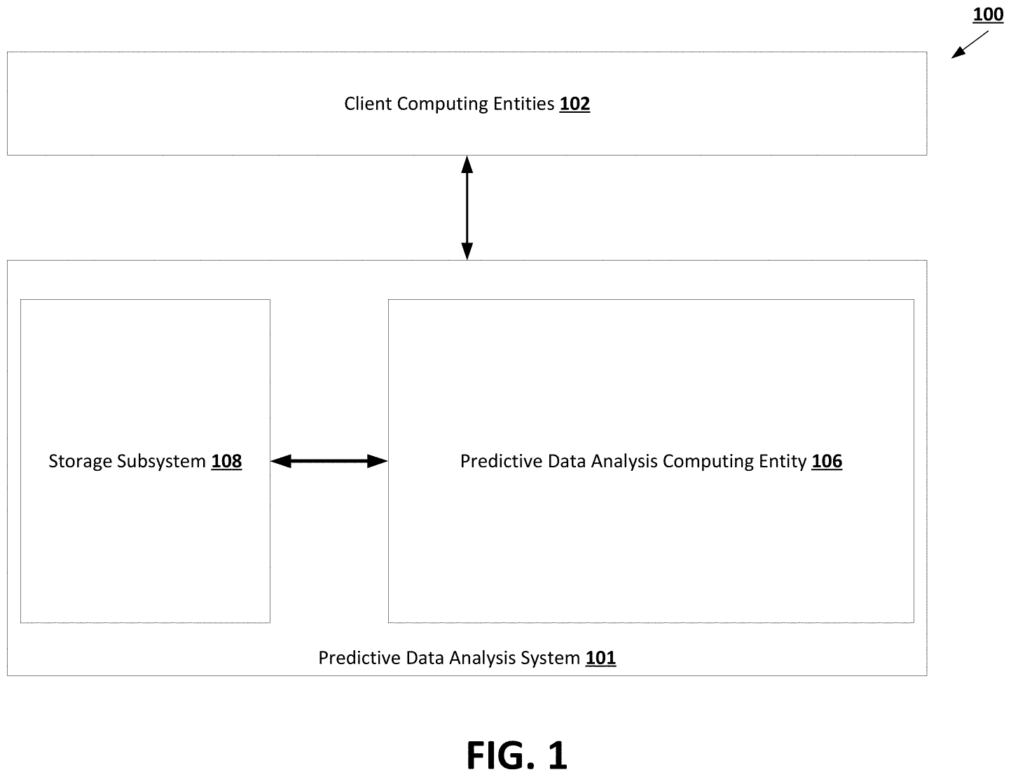

FIG. 1 is a schematic diagram of an example architecture 100 for performing predictive data analysis. The architecture 100 includes a predictive data analysis system 101 configured to receive predictive data analysis requests from client computing entities 102, process the predictive data analysis requests to generate predictions, provide the generated predictions to the client computing entities 102, and automatically perform prediction-based actions based at least in part on the generated predictions. An example of a prediction-based action that can be performed using the predictive data analysis system 101 is a request for generating a reason for visit for a medical visit.

In some embodiments, predictive data analysis system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The predictive data analysis system 101 may include a predictive data analysis computing entity 106 and a storage subsystem 108. The predictive data analysis computing entity 106 may be configured to receive predictive data analysis requests from one or more client computing entities 102, process the predictive data analysis requests to generate predictions corresponding to the predictive data analysis requests, provide the generated predictions to the client computing entities 102, and automatically perform prediction-based actions based at least in part on the generated predictions.

The storage subsystem 108 may be configured to store input data used by the predictive data analysis computing entity 106 to perform predictive data analysis as well as model definition data used by the predictive data analysis computing entity 106 to perform various predictive data analysis tasks. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

A. Exemplary Predictive Data Analysis Computing Entity

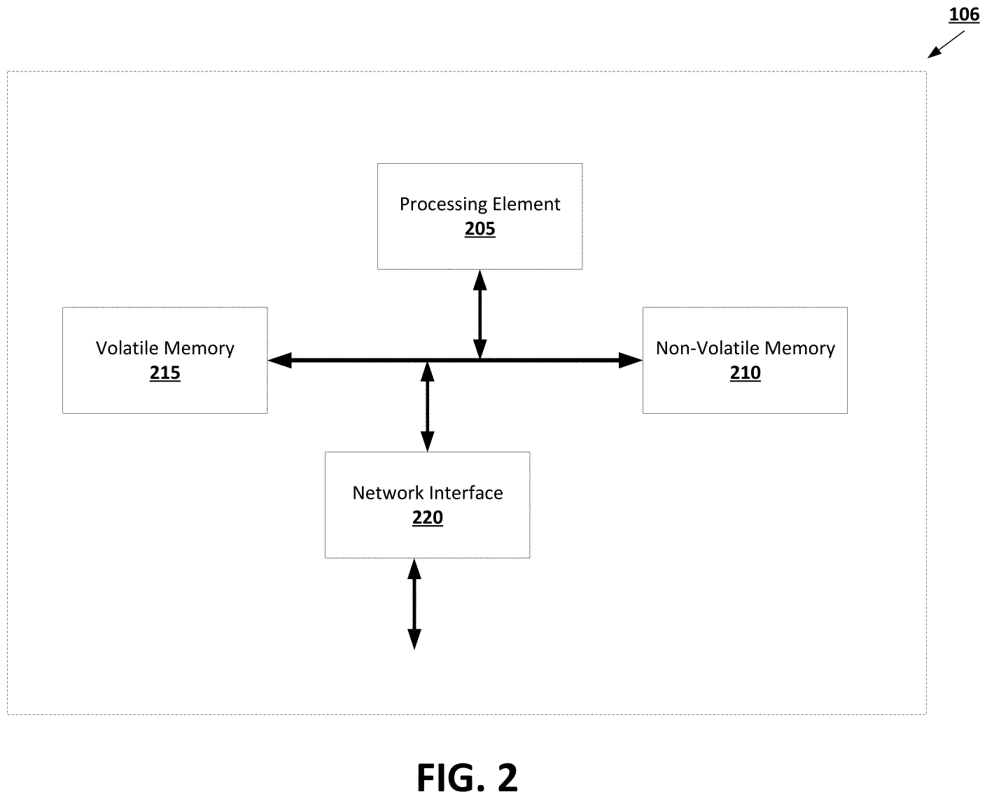

FIG. 2 provides a schematic of a predictive data analysis computing entity 106 according to one embodiment of the present invention. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the predictive data analysis computing entity 106 may include, or be in communication with, one or more processing elements 205 (also referred to as processors, processing circuitry, and/or similar terms used herein interchangeably) that communicate with other elements within the predictive data analysis computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the predictive data analysis computing entity 106 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile storage or memory media 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the predictive data analysis computing entity 106 may further include, or be in communication with, volatile media (also referred to as volatile storage, memory, memory storage, memory circuitry and/or similar terms used herein interchangeably). In one embodiment, the volatile storage or memory may also include one or more volatile storage or memory media 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 106 with the assistance of the processing element 205 and operating system.

As indicated, in one embodiment, the predictive data analysis computing entity 106 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 106 may include, or be in communication with, one or more input elements, such as a keyboard input, a mouse input, a touch screen/display input, motion input, movement input, audio input, pointing device input, joystick input, keypad input, and/or the like. The predictive data analysis computing entity 106 may also include, or be in communication with, one or more output elements (not shown), such as audio output, video output, screen/display output, motion output, movement output, and/or the like.

B. Exemplary Client Computing Entity

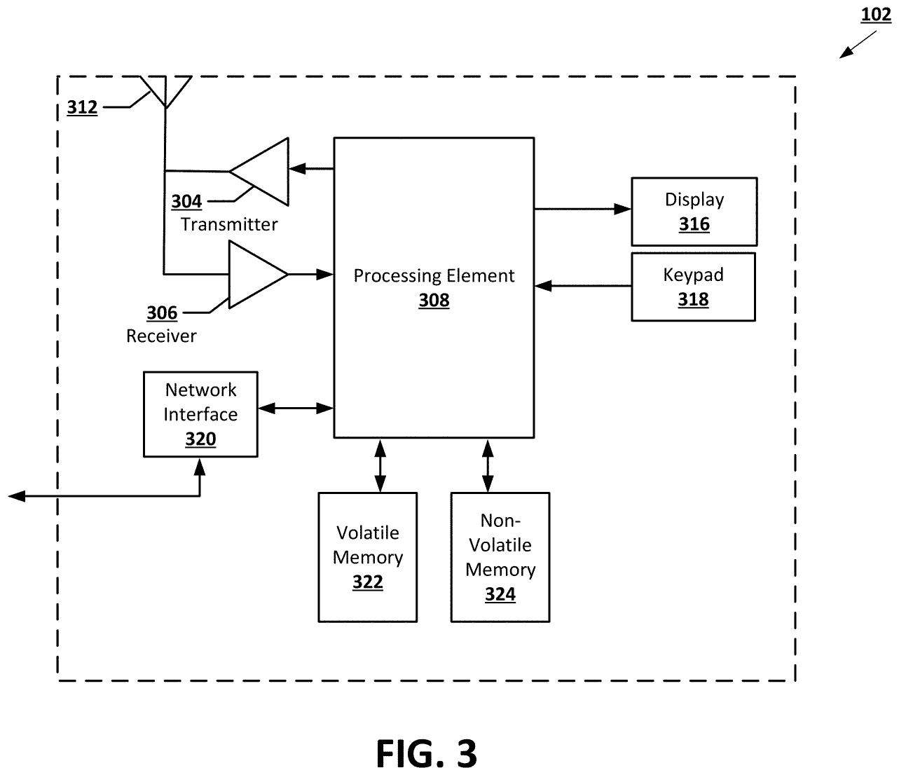

FIG. 3 provides an illustrative schematic representative of a client computing entity 102 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 can be operated by various parties. As shown in FIG. 3, the client computing entity 102 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the predictive data analysis computing entity 106. In a particular embodiment, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the predictive data analysis computing entity 106 via a network interface 320.

Via these communication standards and protocols, the client computing entity 102 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 can also download changes, add-ons, and updates, for instance, to its firmware, software (e.g., including executable instructions, applications, program modules), and operating system.

According to one embodiment, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the client computing entity's 102 position in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 102 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the predictive data analysis computing entity 106, as described herein. The user input interface can comprise any of a number of devices or interfaces allowing the client computing entity 102 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client computing entity 102 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the entity or accessible through a browser or other user interface for communicating with the predictive data analysis computing entity 106 and/or various other computing entities.

In another embodiment, the client computing entity 102 may include one or more components or functionality that are the same or similar to those of the predictive data analysis computing entity 106, as described in greater detail above. As will be recognized, these architectures and descriptions are provided for exemplary purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### V. Exemplary System Operations

As described below, various embodiments of the present invention improve computational efficiency of generating cross-event classifications for predictive entities that are associated with a large number of predictive events by disclosing techniques that generate a cross-event predictive classification for a predictive entity via processing an event relationship network data object associated with the predictive entity using a set of sequential network updates associated with the layers of a network-based inference machine learning model. Given a predictive entity that is associated with E predictive events, a naïve solution to generating a cross-event classification for the predictive entity based at least in part on the E predictive events comprises processing each of the E predictive events using a trained classification machine learning model. If each inference of the trained classification machine learning model involves an average of F₁ floating point operations per second (FLOPS), because E inferences need to be performed in accordance with the naïve solution, then this means that generating a cross-event classification for the predictive entity based at least in part on the E predictive events associated with the predictive entity and in accordance with the naïve approach has a computational complexity of O(E*F₁). In contrast, various embodiments of the present invention generate an event relationship network data object that describes embeddings for all of the E predictive events and process the event relationship network data object using a singular predictive inference of a network-based inference machine learning model to generate the cross-event classification for the corresponding predictive entity. This means that, if each inference of the network-based inference machine learning model involves an average of F₂ FLOPS, because only a single inference of the network-based inference machine learning model is performed in accordance with various embodiments of the present invention, then this means that generating a cross-event classification for the predictive entity performed in accordance with various embodiments of the present invention has a computational complexity of O(F₂). Moreover, because in at least some embodiments the operations of the network-based inference machine learning model comprise a sequence of linear combination operations (e.g., a sequence of matrix multiplication operations), it is expected that F₂=<F₁ (and most likely F₂<F₁), which means that, for E>1, O(F₂) is guaranteed to be less than O(E*F₁), and the performance gap between the two computational complexities increases as the value of E increases.

Accordingly, by reducing the computational complexity of generating a cross-event classification for a predictive entity that is associated with two or more predictive events, and by reducing the number of computer processor operations needed to generate a cross-event classification for a predictive entity that is associated with two or more predictive events, various embodiments of the present invention improve computational efficiency of generating cross-event classifications in relation to predictive entities that are associated with a large number of predictive events.

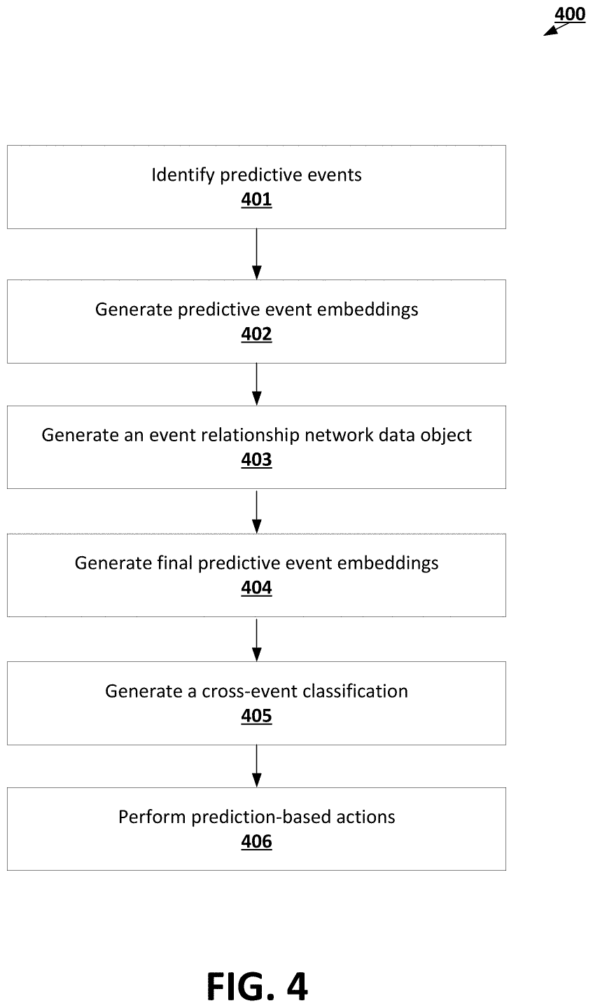

FIG. 4 is a flowchart diagram of an example process 400 for generating a cross-event classification for a predictive entity. Via the various steps/operations of the process 400, the predictive data analysis computing entity 106 can perform a sequence of L sequential network updates on an event relationship network data object for a predictive entity to generate a cross-event classification for the predictive entity.

The process 400 begins at step/operation 401 when the predictive data analysis computing entity 106 identifies (e.g., receives) a plurality of predictive events associated with the predictive entity. In some embodiments, the predictive data analysis computing entity 106 identifies a plurality of predictive events that correspond to “facts” associated with a subject matter with respect to which one or more predictive data analysis operations are performed, such as with respect to a medical visit.

In some embodiments, the predictive entity describes a real-world entity and/or a virtual entity (e.g., a service delivery session, such as a medical visit) with respect to which one or more predictive data analysis operations are performed. For example, the predictive entity may describe a medical visit, and the noted predictive data analysis operations may be configured to describe a reason for visit (RFV) for the medical visit. As another example, the predictive entity may describe a transactional event such as the return of a product, and the noted predictive data analysis operations may be configured to describe a return for the noted transactional event such as the reason for return of the product. As a further example, the predictive entity may describe a system failure for a computer system, and the noted predictive data analysis operations may be configured to describe a reason for the system failure.

In some embodiments, a predictive event describes a recorded state of one or more monitored systems that are determined to be related to a predictive entity. For example, when the predictive entity is a medical visit, the predictive events associated with the predictive entity may include at least a subset of medical codes (e.g., diagnosis codes, procedure codes, pharmacy codes, and/or the like) and/or at least a subset of medical conditions associated with a corresponding patient identifier for the medical visit, such as the medical codes of the noted patient identifier that are associated with medical visits whose respective occurrence/recordation timestamps fall within a threshold proximity of a timestamp associated with the medical visit. As another example, when the predictive entity is a system failure of a particular software system, the predictive events associated with the predictive entity may include at least a subset of software alert data objects that are captured by a software monitoring framework associated with the particular software system. In some embodiments, given a set of monitored systems associated with a predictive entity, the predictive events for the predictive entity include at least a subset of the predictive events generated by the set of monitored systems whose timestamps are within a threshold proximity of a timestamp associated with the predictive entity, such as a subset of the predictive events generated by the set of monitored systems whose timestamps are within the threshold proximity of the timestamp associated with the predictive entity and whose associated user identifiers correspond to a user identifier of the predictive entity.

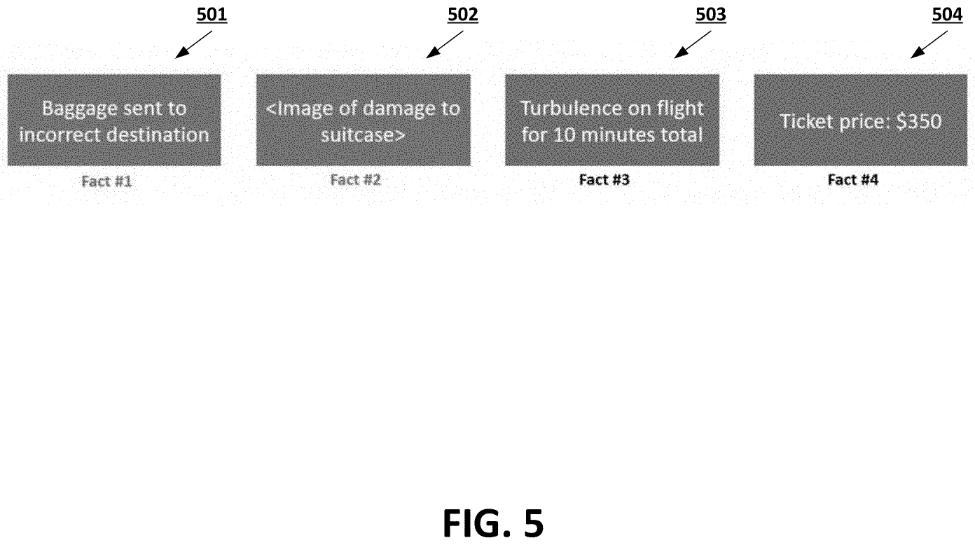

An operational example of a set of predictive events associated with a predictive entity that corresponds to a customer-initiated airline complaint are depicted in FIG. 5. As depicted in FIG. 5, each box corresponds to a predictive entity that is a candidate reason for occurrence of the customer-initiated airline complaint. For example, box 501 corresponds to a predictive event describing a recorded observation that the baggage of a corresponding customer was sent to an incorrect destination. As another example, box 502 corresponds to a predictive event depicting an image of a damaged suitcase of the corresponding customer. As yet another example, box 503 corresponds to a predictive event describing a recorded observation that, during a ten-minute portion of the flight period associated with the corresponding flight, there was turbulence. As a further example, box 504 corresponds to a predictive event describing a recorded observation that the corresponding ticket price cost $350.

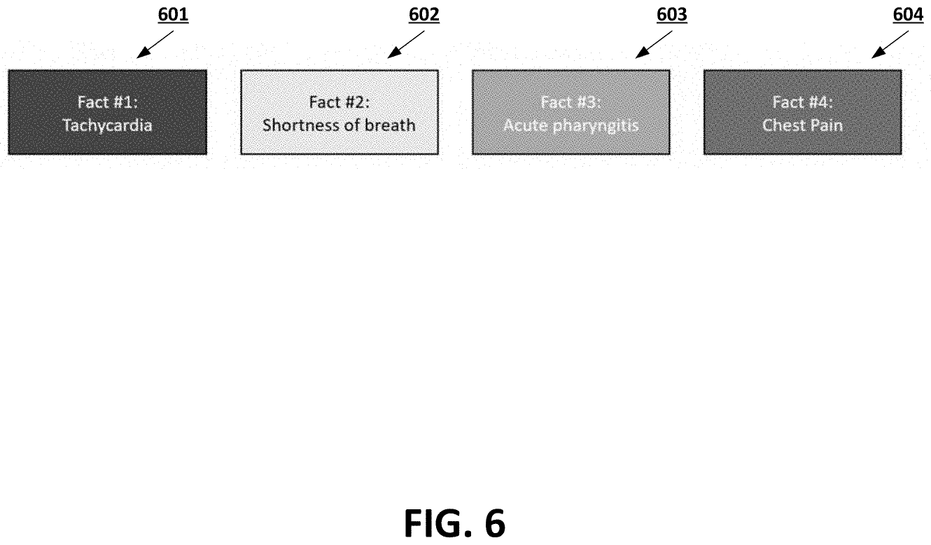

An operational example of a set of predictive events associated with a predictive entity that corresponds to an emergency room visit are depicted in FIG. 6. As depicted in FIG. 5, each box corresponds to a predictive entity that is a candidate RFV medical condition for the emergency room visit. For example, box 601 corresponds to a predictive event describing a recorded observation that the corresponding patient experienced tachycardia. As another example, box 602 corresponds to a predictive event describing a recorded observation that the corresponding patient experienced shortness of breath. As yet another example, box 603 corresponds to a predictive event describing a recorded observation that the corresponding patient experienced acute pharyngitis. As a further example, box 604 corresponds to a predictive event describing a recorded observation that the corresponding patient experienced chest pain.

Returning to FIG. 4, at step/operation 402, the predictive data analysis computing entity 106 generates, for each predictive event, a predictive event embedding. In some embodiments, a predictive event embedding machine learning model processes each predictive event to generate the predictive event embedding for the noted predictive event. In some embodiments, each predictive event embedding has a uniform size, e.g., comprises N₀ values.

A predictive event embedding may be a fixed-length representation of a corresponding predictive event, where an initial value of the predictive event embedding may be generated by processing input data associated with the corresponding predictive event using a predictive event embedding machine learning model. For example, the initial value for the predictive event embedding for an image-based predictive event describing an image may describe a fixed-length representation of the image that is generated by processing the image using an image embedding component of the predictive event embedding machine learning model, such as an image embedding component that comprises a two-dimensional convolutional neural network. As another example, the initial value for the predictive event embedding for a text-based predictive event describing a text document data object may describe a fixed-length representation of the text document data object that is generated by processing the text document data object using a text embedding component of the predictive event embedding machine learning model, such as a text embedding component that uses one or more attention mechanisms (e.g., one or more self-attention mechanisms, such as one or more bidirectional self-attention mechanisms). As a further example, the initial value for the predictive event for a categorical predictive event describing a categorical feature may describe a fixed-length representation of the categorical feature that is generated by processing the categorical feature using a categorical feature embedding component of the predictive event embedding machine learning model, such as a categorical feature embedding component that uses a one-hot-encoding mechanism.

As described above, in some embodiments, each predictive event embedding has a uniform size, e.g., comprises N₀ values. For example, in some embodiments, given a predictive entity that is associated with E predictive events, E predictive event embeddings are generated, where each of the E predictive event embeddings comprises N₀ values. In some embodiments, the predictive event embedding for a particular predictive event having a particular data format is generated by processing data associated with the particular predictive event using an embedding component of a predictive event machine learning model that is associated with the particular data format.

In some embodiments, a predictive event embedding machine learning model is configured to process a predictive event to generate a predictive event embedding for the predictive event. As described above, given E predictive events that are associated with F data formats, the predictive event embedding machine learning model may comprise F embedding components, where each embedding component is configured to process those predictive events having a particular data format to generate corresponding predictive event embeddings. For example, the predictive event embedding machine learning model may comprise at least one of the following: (i) an image embedding component that is configured to process the image associated with an image-based predictive event to generate the predictive event embedding for the noted image-based predictive event, (ii) a text embedding component that is configured to process the text data object data object associated with a text-based predictive event to generate a predictive event embedding for the text-based predictive event, or (iii) a categorical feature embedding component that is configured to process the categorical feature associated with a categorical predictive event to generate a predictive event embedding for the categorical predictive event.

In some embodiments, when a predictive event embedding machine learning model comprises F embedding components, the inputs to each embedding component may have a different dimensionality and/or size, while the outputs of the F embedding components all have a uniform size, e.g., all comprise N₀ values. For example, the inputs to an image embedding component of the predictive event embedding machine learning model may include a matrix describing pixel values of an input image. As another example, the inputs to a text embedding component of the predictive event embedding machine learning model may include T vectors each corresponding to an input representation (e.g., a one-hot-encoded representation, a Word2Vec-generated representation, and/or the like) of a token/word of an input text document data object. As a further example, the inputs to a categorical feature embedding component of the predictive event embedding machine learning model may include a vector describing a one-hot-encoded representation of an input categorical feature. In some embodiments, outputs of a predictive event embedding machine learning model comprise a vector describing a predictive event embedding that has a uniform size, e.g., comprises N₀ values.

In some embodiments, the predictive event embedding machine learning model is trained in an end-to-end manner along with a network-based inference machine learning model, where the network-based inference machine learning model is configured to (during the training process) process an event relationship network data object for a training predictive entity that is generated based at least in part on each predictive event embedding for the training predictive entity to generate an inferred cross-event classification for the training predictive entity. Then, a training model (e.g., an error function, an objective function, and/or the like) is generated for the machine learning framework comprising the predictive event embedding machine learning model and the network-based inference machine learning model based at least in part on the measure of deviation between the inferred cross-event classification for the training predictive entity and a ground-truth cross-event classification for the training predictive entity as described by the training data for the machine learning framework. Then, parameters of the machine learning framework are updated by optimizing (e.g., globally optimizing, locally optimizing such as via one or more gradient descent operations, and/or the like) the training model, where optimizing the training model may comprise backpropagating a gradient of the error model across the machine learning framework. In some embodiments, the ground-truth cross-event classifications for training predictive entities are generated based at least in part on historical data and/or data provided by subject matter experts, such as based at least in part on historical data describing ground-truth RFV medical conditions for historical medical visits.

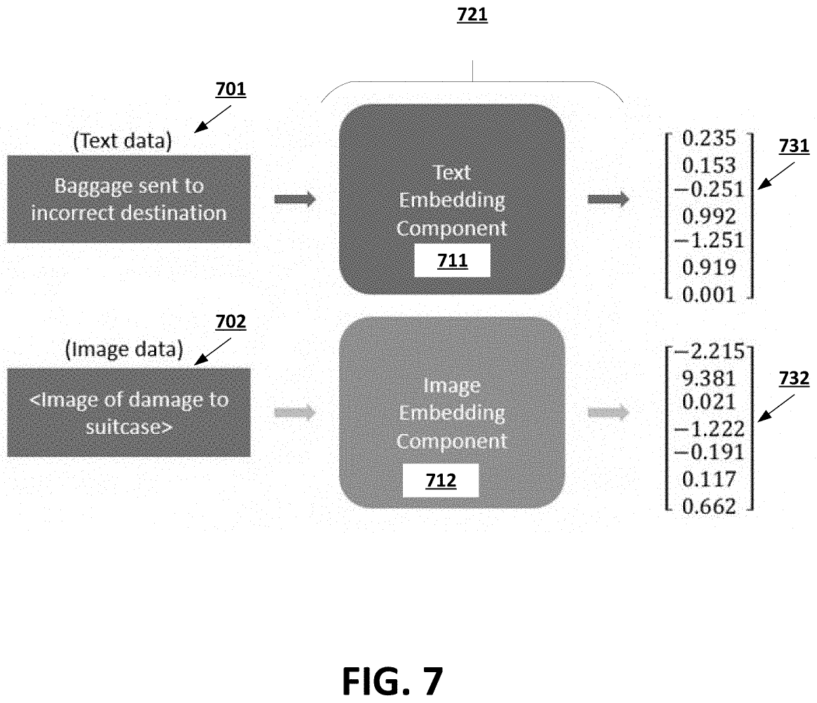

An operational example of generating predictive event embeddings for a predictive entity that is associated with two predictive events is depicted in FIG. 7. As depicted in FIG. 7, the predictive entity is associated with two predictive events: the predictive event 701 that is associated with a text data format and the predictive event 702 that is associated with an image data format. As further depicted in FIG. 7, the predictive event 701 is processed by a text embedding component 711 of a predictive event embedding machine learning model 721 to generate the predictive event embedding 731 for the predictive event 701, while the predictive event 702 is processed by an image embedding component 712 of the predictive event embedding machine learning model 721 to generate the predictive event embedding 732 for the predictive event 702. As further depicted in FIG. 7, both the predictive event embedding 731 and the predictive event embedding 732 comprise N₀=7 values and thus have the same size.

Returning to FIG. 4, at step/operation 403, the predictive data analysis computing entity 106 generates an event relationship graph data object for the predictive entity based at least in part on each predictive event embedding for the predictive entity. In some embodiments, given a predictive entity that comprises E predictive events, the event relationship graph data object for the predictive entity that describes all of the E predictive event embeddings for all of the E predictive events of the predictive entity.

An event relationship network data object may describe a network corresponding to a fully-connected graph (i.e., a graph where each node pair is connected via a link/edge), where each node of the network corresponds to a predictive event of a particular predictive entity and describes the predictive event embedding for the predictive event that is associated with the node. In some embodiments, the event relationship network data object describes a set of links between the nodes of the event relationship network data object, where each link is associated with a node pair corresponding to a predictive event pair and describes a relationship embedding for an event relationship link between the predictive event pair that corresponds to the node pair. For example, given a predictive entity that is associated with E predictive entities, the event relationship network data object may comprise E nodes and

$$R = \frac{E !}{2 ( E - 2 ) !}$$

links/edges, where each node describes the predictive event embedding for a corresponding predictive event, and each link/edge is an event relationship link between a first predictive event and a second predictive event which describes a relationship embedding for the event relationship link.

In some embodiments, the event relationship graph data object for a predictive entity is described by two two-dimensional data objects (e.g., two two-dimensional array data objects, two two-dimensional data objects each describing a two-dimensional matrix, and/or the like): an event-related two-dimensional data object (e.g., an event-related matrix data object) that describes predictive event embeddings for the predictive events associated with the predictive entity, and a relationship-related two-dimensional data object (e.g., a relationship-related matrix data object) that describes relationship embeddings for the event relationship links associated with the predictive entity. This may mean that, when initially generated, the event relationship graph data object may comprise: (i) an event-related two-dimensional data object that is an E*N₀ data object, where E describes the number of predictive events of the predictive entity, and N₀ describes the uniform size of each of the E initially-generated predictive event embeddings for the E predictive events of the predictive entity; and (ii) a relationship-related two-dimensional data object that is an R*K₀ two-dimensional data object, where R describes the number of event relationship links of the predictive entity and K₀ may describe the uniform size of each of the R initially-generated relationship embeddings for the R event relationship links of the predictive entity.

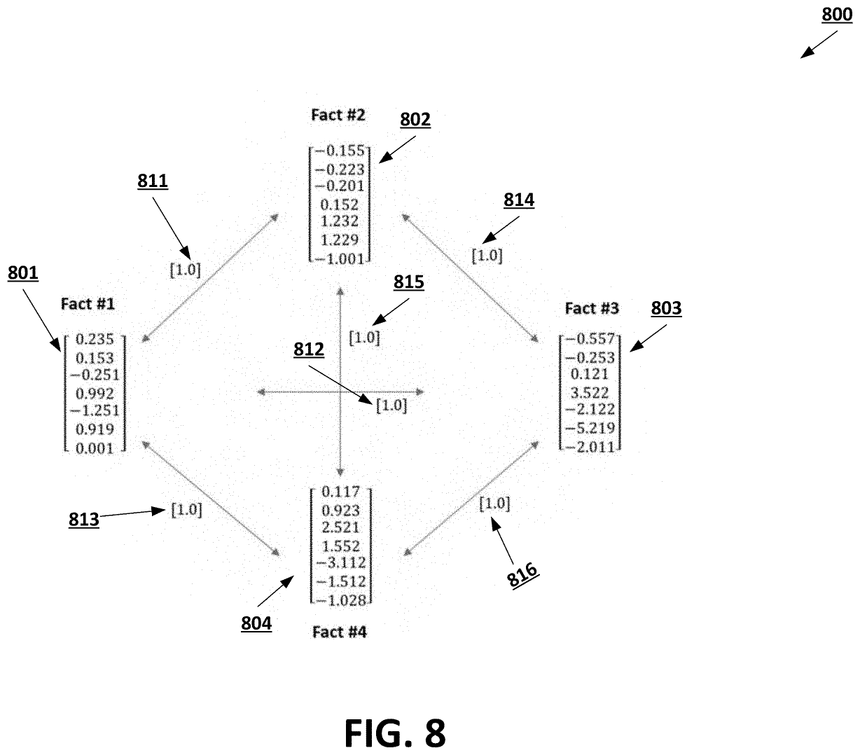

An operational example of an event relationship network data object 800 as initially generated (i.e., before any updates by a network-based inference machine learning model as described below) is depicted in FIG. 8. As depicted in FIG. 8, the event relationship network data object 800 comprises E=4 predictive events associated with four corresponding predictive event embeddings, as well as

$$R = \frac{4 !}{2 ( 4 - 2 ) !} = 6$$

event relationship links associated with six corresponding relationship embeddings. As further depicted in FIG. 8, the four predictive event embeddings described by the event relationship network data object 800 include: (i) the predictive event embedding 801 for a first predictive event, (ii) the predictive event embedding 802 for a second predictive event, (iii) the predictive event embedding 803 for a third predictive event, and (iv) the predictive event embedding 804 for a fourth predictive event.

As further depicted in FIG. 8, the six relationship embeddings of the event relationship network data object 800 comprise: (i) the relationship embedding 811 for a first event relationship link between the first predictive event and the second predictive event, (ii) the relationship embedding 812 for a second event relationship link between the first predictive event and the third predictive event, (iii) the relationship embedding 813 for a third event relationship link between the first predictive event and the third predictive event, (iv) the relationship embedding 814 for a fourth event relationship link between the second predictive event and the third predictive event, (v) the relationship embedding 815 for a fifth event relationship link between the second predictive event and the fourth predictive event, and (vi) the relationship embedding 816 for a sixth event relationship link between the third predictive event and the fourth predictive event. As depicted in FIG. 8, each relationship embedding is in some embodiments initialized to represent a common vector (e.g., a common 1-sized vector with the value 1.0).

In some embodiments, a relationship embedding describes a fixed-size representation of an event relationship link between a first predictive event and a second predictive event. In some embodiments, given a predictive entity that is associated with R event relationship links, the R relationship embeddings for the R event relationship links are initialized using an initialization strategy, such as: (i) an initialization strategy that assigns a common vector (e.g., a [1.0] vector) to each of the R relationship embeddings, (ii) an initialization strategy that assigns a vector [x] vector to each relationship embedding, where x is a ground-truth relationship significance measure for the event relationship link that is associated with the relationship embedding, and (iii) an initialization strategy that assigns a vector [x] vector to each relationship embedding, where x is an inferred relationship significance measure for the event relationship link that is associated with the relationship embedding. In some embodiments, the inferred relationship significance measure for an event relationship link between a first predictive entity and a second predictive entity is generated based at least in part on the output of processing the first predictive entity and the second predictive entity using a relationship embedding machine learning model. In some embodiments, the inferred relationship significance measure for an event relationship link between a first predictive entity and a second predictive entity is generated based at least in part on the output of processing the predictive event embedding for the first predictive entity and the predictive event embedding for second predictive entity using a relationship embedding machine learning model.

Returning to FIG. 4, at step/operation 404, the predictive data analysis computing entity 106 generates a final predictive event embedding for the predictive entity and a final relationship embedding for the predictive entity based at least in part on the event relationship network data object. In some embodiments, the predictive data analysis computing entity 106 performs, via the operations corresponding to the L sequential network update layers of a network-based inference machine learning model, L sequential network updates on the event relationship network data object. During each sequential network update performed by a particular sequential network update layer of the network-based inference machine learning model, a latest state of the event relationship network data object is updated via processing the event relationship network data object based at least in part on the trained parameters of the particular sequential network update layer. This means that, after being processed by the L sequential network update layers of the network-based inference machine learning model, the event relationship network data object still has the same network architecture describing E event nodes and R event relationship links, but that the E predictive event embeddings and the R relationship embeddings have each gone through L transformations. In some of the noted embodiments, a final predictive event embedding is a predictive event embedding described by an event relationship network data object that is generated after L transformations of the event relationship network data object by the L sequential network update layers of the network-based inference machine learning model, while a final relationship embedding is a relationship embedding described by an event relationship network data object that is generated after L transformations of the event relationship network data object by the L sequential network update layers of the network-based inference machine learning model.

In some embodiments, a network-based inference machine learning model is configured to perform L sequential updates on an event relationship network data object for a predictive entity. During each sequential update that is performed by a respective sequential network update layer of the network-based inference machine learning model, at least one of the predictive event embeddings and/or at least one of the relationship embeddings described by the event relationship network data object may be updated based at least in part on one or more trained parameters associated with the respective network sequential update layer. For example, operations associated with a first sequential update performed by a first sequential network update layer may comprise: (i) identifying the originally-generated event relationship network data object that comprises an E*N₀ event-related two-dimensional data object and an R*K₀ relationship-related two-dimensional data object, (ii) multiplying the E*N₀ event-related two-dimensional data object by an N₀*N₁ two-dimensional event-related parameter data object (e.g., an N₀*N₁ weight matrix) that describes N₀*N₁ event-related trained parameter values to generate an updated E*N₁ event-related two-dimensional data object, (iii) multiplying the R*K₀ relationship-related two-dimensional data object by a K₀*K₁ two-dimensional relationship-related parameter data object (e.g., a K₀*K₁ weight matrix) that describes K₀*K₁ relationship-related trained parameter values to generate an updated R*K₁ relationship-related two-dimensional data object, and (ii) generating an updated event relationship network data object by combining the updated E*N₁ event-related two-dimensional data object and the updated R*K₁ relationship-related two-dimensional data object. In some embodiments, N₁ and K₁ are hyper-parameters of the first sequential network update layer of the network-based inference machine learning model.

As another example, operations associated with a second sequential updated performed by a second sequential network update layer comprise: (i) identifying an input event relationship network data object that is generated after the sequential network update performed by the first sequential network update layer and comprises the E*N₁ event-related two-dimensional data object and the updated R*K₁ relationship-related two-dimensional data object, (ii) multiplying the E*N₁ event-related two-dimensional data object by an N₁*N₂ two-dimensional event-related parameter data object (e.g., an N₁*N₂ weight matrix) that describes N₁*N₂ event-related trained parameter values to generate an updated E*N₂ event-related two-dimensional data object, (iii) multiplying the R*K₁ relationship-related two-dimensional data object by a K₁*K₂ two-dimensional relationship-related parameter data object (e.g., a K₁*K₂ weight matrix) that describes K₁*K₂ relationship-related trained parameter values to generate an updated R*K₂ relationship-related two-dimensional data object, and (ii) generating an updated event relationship network data object by combining the updated E*N₂ event-related two-dimensional data object and the updated R*K₂ relationship-related two-dimensional data object. In some embodiments, N₂ and K₂ are hyper-parameters of the second sequential network update layer of the network-based inference machine learning model.

In some embodiments, each ith sequential update layer: (i) is associated with an ith layer event-related parameter data object that is Nᵢ₋₁*Nᵢ two-dimensional event-related parameter data object describing Nᵢ₋₁*Nᵢ event-related trained parameter values, (ii) is associated with an ith layer relationship-related parameter data object that is Kᵢ₋₁*Kᵢ two-dimensional relationship-related parameter data object describing Kᵢ₋₁*Kᵢ event-related trained parameter values, and (iii) is configured to: (a) identify an input event relationship network data object that describes an input E*Nᵢ₋₁ event-related two-dimensional data object and an input R*Kᵢ₋₁ relationship-related two-dimensional data object, (b) multiply the input E*Nᵢ₋₁ event-related two-dimensional data object with the ith layer event-related parameter data object to generate an updated E*Nᵢ event-related two-dimensional data object, (c) multiply the input R*Kᵢ₋₁ relationship-related two-dimensional data object with the ith layer relationship-related parameter data object to generate an updated R*Kᵢ relationship-related two-dimensional data object, and (d) generate an updated event relationship network data object that comprises the updated E*Nᵢ event-related two-dimensional data object and the updated R*Kᵢ relationship-related two-dimensional data object.

In some embodiments, if the ith sequential update layer is an initial sequential update layer, then the input event relationship network data object for the ith sequential update layer is the originally-generated event relationship network data object. In some embodiments, if the ith sequential update layer is a non-initial sequential update layer, then the input event relationship network data object for the ith sequential update layer is the updated event relationship network data object generated by an immediately preceding (i.e., an (i−1)th) sequential update layer. In some embodiments, if the ith sequential update layer is a non-final sequential update layer, then the updated event relationship network data object generated by the ith sequential update layer is provided as the input event relationship network data object to an immediately succeeding (i.e., an (i+1)th) sequential update layer. In some embodiments, if the ith sequential update layer is a final sequential update layer, then the updated event relationship network data object generated by the ith sequential update layer is used to generate final predictive event embeddings and final relationship embeddings. In some embodiments, each ith sequential update layer is associated with at least two hyperparameters: an Nᵢ hyperparameter that describes the size of the updated predictive event embeddings generated by the ith sequential update layer, and a Kᵢ hyperparameter that describes the size of the updated relationship embeddings generated by the ith sequential update layer.

In some embodiments, inputs to the network-based inference machine learning model comprise two matrices: one describing the event-related two-dimensional data object of an initially-generated event relationship network data object, and the other describing the relationship-related two-dimensional data object of the initially-generated event relationship network data object. In some embodiments, outputs of the network-based inference machine learning model comprise two matrices: one describing the event-related two-dimensional data object of an updated event relationship network data object generated by a final sequential network update layer of the network-based inference machine learning model, and the other describing the relationship-related two-dimensional data object of the updated event relationship network data object generated by the final sequential network update layer of the network-based inference machine learning model.

As described above, the network-based inference machine learning model may be trained concurrently with a predictive event embedding machine learning model by training a machine learning framework that comprises both of the noted machine learning frameworks. In some embodiments, the predictive event embedding machine learning model is trained in an end-to-end manner along with a network-based inference machine learning model, where the network-based inference machine learning model is configured to (during the training process) process an event relationship network data object for a training predictive entity that is generated based at least in part on each predictive event embedding for the training predictive entity to generate an inferred cross-event classification for the training predictive entity. Then, a training model (e.g., an error function, an objective function, and/or the like) is generated for the machine learning framework comprising the predictive event embedding machine learning model and the network-based inference machine learning model based at least in part on the measure of deviation between the inferred cross-event classification for the training predictive entity and a ground-truth cross-event classification for the training predictive entity as described by the training data for the machine learning framework. Then, parameters of the machine learning framework are updated by optimizing (e.g., globally optimizing, locally optimizing such as via one or more gradient descent operations, and/or the like) the training model, where optimizing the training model may comprise backpropagating a gradient of the error model across the machine learning framework. In some embodiments, the ground-truth cross-event classifications for training predictive entities are generated based at least in part on historical data and/or data provided by subject matter experts, such as based at least in part on historical data describing ground-truth RFV medical conditions for historical medical visits.=

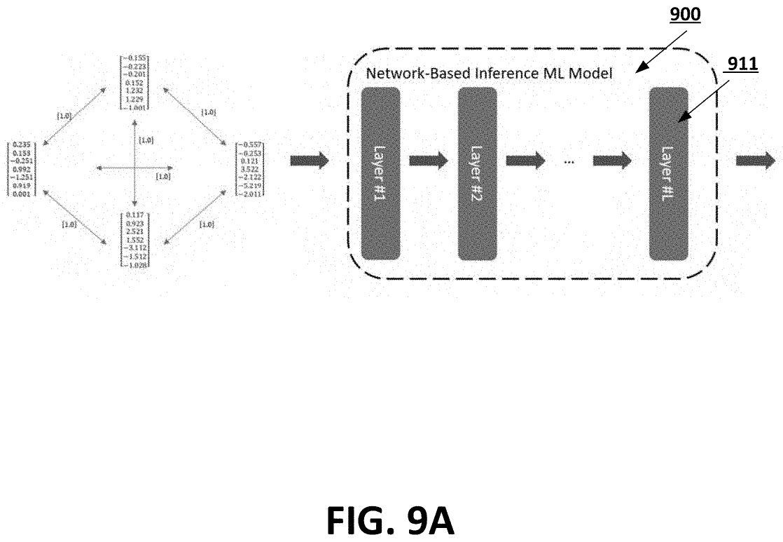

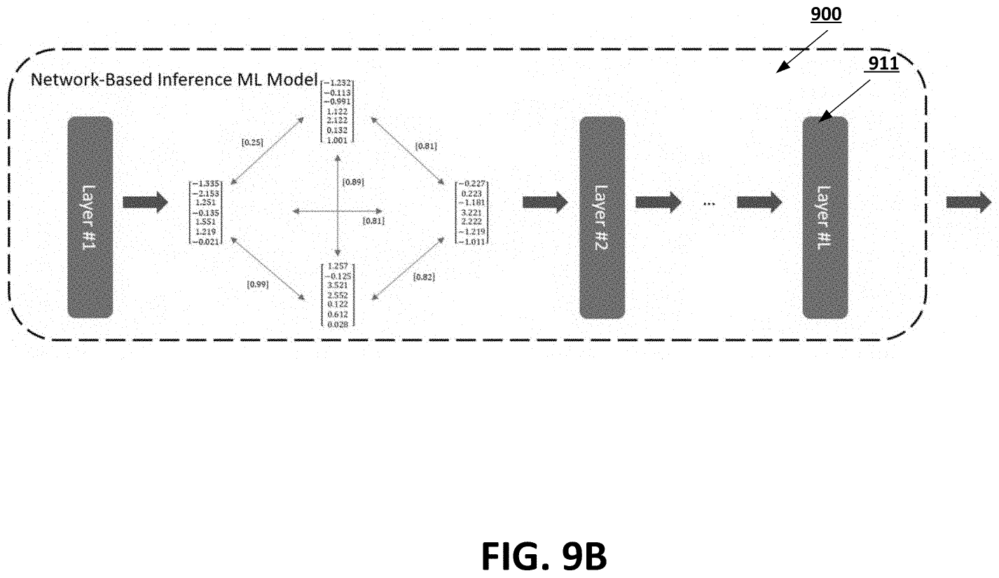

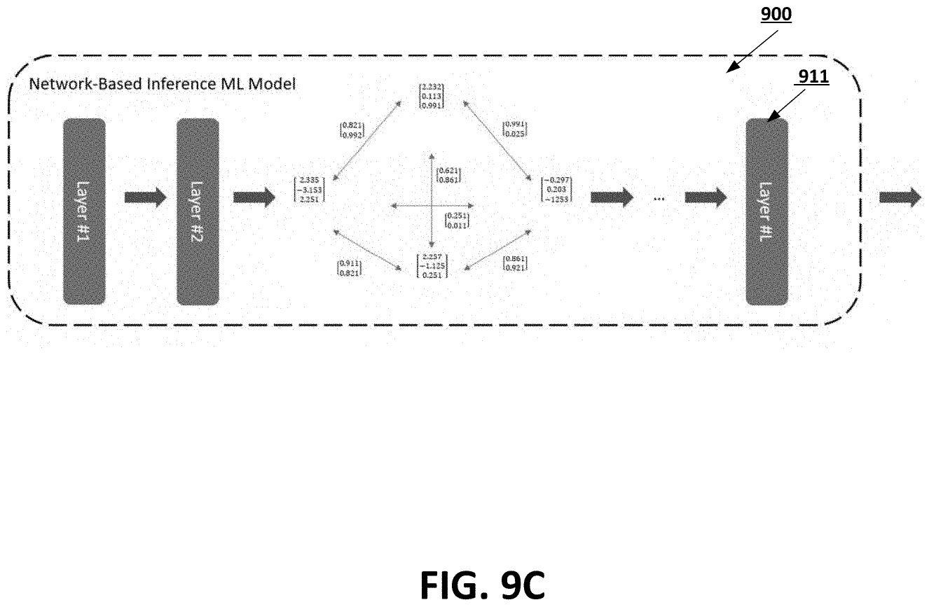

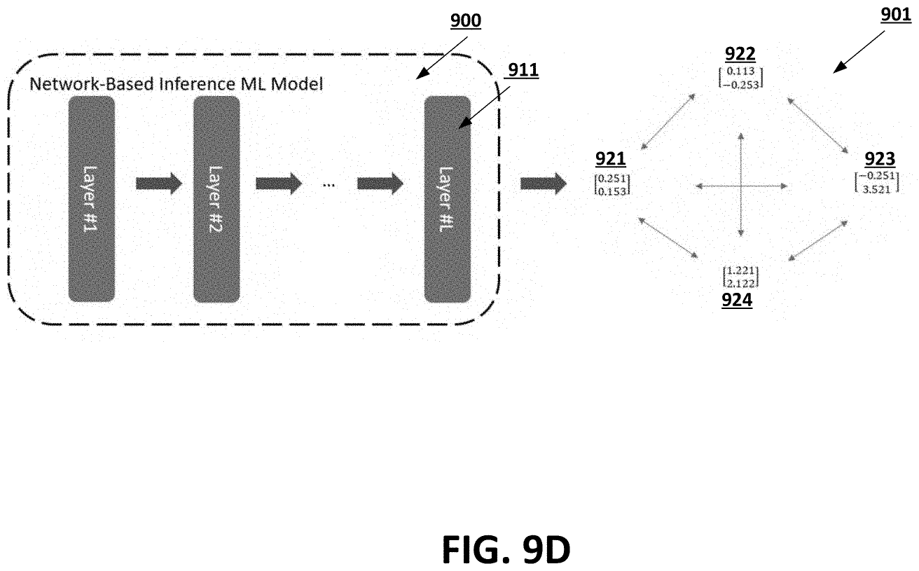

An operational example of a network-based inference machine learning model 900 that comprises L sequential network update layers is depicted in FIGS. 9A-9D. As depicted in FIG. 9, each sequential network update layer is configured to process an input event relationship network data object to generate an updated event relationship network data object. The updated event relationship network data object 901 generated by a final sequential network update layer 911 comprises the final predictive event embeddings for the four predictive events associated with the corresponding predictive entity. For example, as depicted in FIG. 9D, the updated event relationship network data object 901 generated by the final sequential network update layer 911 comprises the final predictive event embedding 921 for the first predictive event associated with the corresponding predictive entity, the final predictive event embedding 922 for the second predictive event associated with the corresponding predictive entity, the final predictive event embedding 923 for the third predictive event associated with the corresponding predictive entity, and the final predictive event embedding 924 for the fourth predictive event associated with the corresponding predictive entity.

Returning to FIG. 4, at step/operation 405, the predictive data analysis computing entity 106 generates the cross-event classification for the predictive entity based at least in part on at least one of the final predictive event embeddings generated by the network-based inference machine learning model or the final relationship embeddings generated by the network-based inference machine learning model. In some embodiments, the cross-event classification for a predictive entity describes, for each predictive event of the E predictive events associated with the predictive entity, a per-event classification that is determined based at least in part on the final predictive event embedding for the predictive event as generated by the network-based inference machine learning model.

A cross-event classification may describe the output of a predictive inference performed with respect to a corresponding predictive entity based at least in part on a set of predictive events associated with the predictive event. For example, the cross-event classification for a predictive entity that is associated with a medical visit may describe an inferred/predicted RFV for the medical visit. As another example, the cross-event classification for a predictive entity that is associated with a transactional activity may describe an inferred/predictive reason for the transactional activity. As a further example, the cross-event classification for a predictive entity that is associated with a computer system failure may describe an inferred/predictive cause of the noted computer system failure.

In some embodiments, given a predictive entity that is associated with E predictive events, the cross-event classification for the predictive entity is determined based at least in part on E per-event classifications for the E predictive events. In some of the noted embodiments, each per-event classification for a predictive event describes whether the predictive event is predicted to be a significant reason for the predictive entity. For example, when the predictive entity describes a medical visit, and when the medical visit is associated with a set of medical conditions corresponding to a set of predictive events for the predictive entity, each predictive event is associated with a per-event classification that describes whether the corresponding medical condition is predicted to be an RFV for the medical visit. In some embodiments, when a predictive event is predicted to be a significant reason for the predictive entity, the predictive event is associated with an affirmative per-event classification. In some embodiments, when a predictive event is predicted to not be a significant reason for the predictive entity, the predictive event is associated with a negative per-event classification. In some embodiments, the cross-event classification for a predictive entity describes at least one of the following: (i) which predictive events of the predictive entity are associated with affirmative per-event classifications, or (ii) which predictive events of the predictive entity are associated with negative per-event classifications.

A per-event classification may describe a predicted determination about contribution of a corresponding predictive event to a predictive entity. For example, the per-event classification for a predictive event may describe whether the predictive event is predicted to be a significant reason for the predictive entity. As another example, the per-event classification for a predictive event may describe a selected predictive event significance classification for the predictive entity that is selected from a group of defined predictive event classifications for the predictive entity. In an exemplary embodiment, the group of defined predictive event classifications for a predictive entity may comprise a positive predictive event classification that is assigned to a predictive event for a predictive entity if the predictive event is predicted to have a positive correlation with the predictive entity, a negative predictive event classification that is assigned to a predictive event for a predictive entity if the predictive event is predicted to have a negative correlation with the predictive entity, and a neutral predictive event classification that is assigned to a predictive event for the predictive entity if the predictive event is predicted to have no correlation with the predictive entity.

In some embodiments, the per-event classification for a particular predictive event is generated based at least in part on whether an ith value of the final predictive event embedding for the particular predictive event satisfies (e.g., exceeds) a threshold value defined based at least in part on a jth value of the final predictive event embedding for the particular predictive event (e.g., whether the ith value of the final predictive event embedding for the particular predictive event exceeds the jth value of the final predictive event embedding for the particular predictive event). In some of the noted embodiments, if the ith value of the final predictive event embedding for the particular predictive event satisfies a threshold value defined based at least in part on a jth value of the final predictive event embedding for the particular predictive event (e.g., if the ith value of the final predictive event embedding for the particular predictive event exceeds the jth value of the final predictive event embedding for the particular predictive event), then the particular predictive event is assigned an affirmative per-event classification. However, in some embodiments, if the ith value of the final predictive event embedding for the particular predictive event fails to satisfy a threshold value defined based at least in part on a jth value of the final predictive event embedding for the particular predictive event (e.g., if the ith value of the final predictive event embedding for the particular predictive event fails to exceed the jth value of the final predictive event embedding for the particular predictive event), then the particular predictive event is assigned a negative per-event classification.

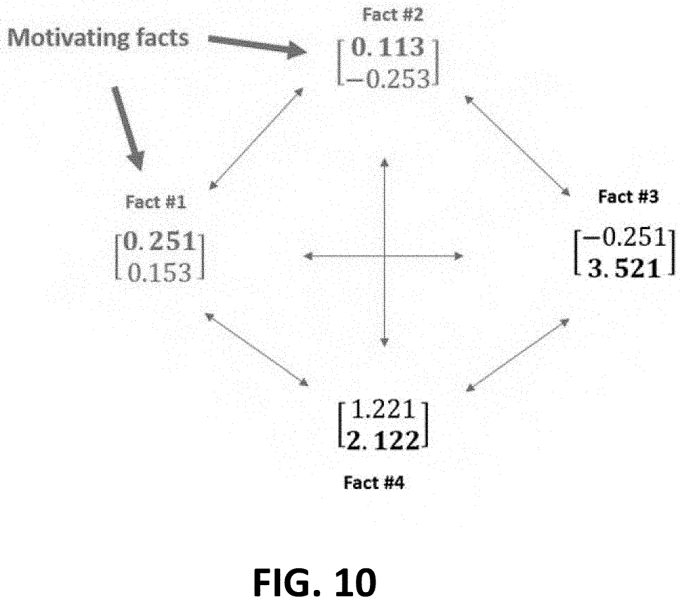

For example, in some embodiments, given i=1 and j=2, a predictive event may be assigned an affirmative per-event classification if the first value of the final predictive event embedding for the predictive event exceeds the second value of the final the final predictive event embedding for the predictive event; however, the predictive event may be assigned a negative per-event classification if the first value of the final predictive event embedding for the predictive event fails to exceed the second value of the final the final predictive event embedding for the predictive event. According to the per-event classification logic of this example, in the operational example of FIG. 10: (i) the first predictive event is assigned an affirmative per-event classification because the first value of the final predictive event embedding for the first predictive event (i.e., the value of 0.251) exceeds the second value of the final predictive event embedding for the first predictive event (i.e., the value of 0.153), (ii) the second predictive event is assigned an affirmative per-event classification because the first value of the final predictive event embedding for the second predictive event (i.e., the value of 0.113) exceeds the second value of the final predictive event embedding for the second predictive event (i.e., the value of −0.253), (iii) the third predictive event is assigned a negative per-event classification because the first value of the final predictive event embedding for the third predictive event (i.e., the value of −0.251) fails to exceed the second value of the final predictive event embedding for the third predictive event (i.e., the value of 3.521), and (iv) the fourth predictive event is assigned a negative per-event classification because the first value of the final predictive event embedding for the fourth predictive event (i.e., the value of 1.221) fails to exceed the second value of the final predictive event embedding for the fourth predictive event (i.e., the value of 2.1222).

In some embodiments, the per-event classification for a particular predictive event describes a selected predictive event significance classification for the particular predictive event, where the selected predictive event significance classification is determined based at least in part on a maximal value position indicator for a maximal value of the final predictive event embedding of the particular predictive event that describes the position of the largest value of the final predictive event embedding. For example, in some embodiments, if the largest value of the final predictive event embedding of the particular predictive event is the first value of the final predictive event embedding of the particular predictive event, then the particular predictive event is assigned a per-event classification that describes a positive predictive event significance classification as the selected predictive event significance classification for the particular predictive event. As another example, in some embodiments, if the largest value of the final predictive event embedding of the particular predictive event is the second value of the final predictive event embedding of the particular predictive event, then the particular predictive event is assigned a per-event classification that describes a neutral predictive event significance classification as the selected predictive event significance classification for the particular predictive event. As a further example, in some embodiments, if the largest value of the final predictive event embedding of the particular predictive event is the third value of the final predictive event embedding of the particular predictive event, then the particular predictive event is assigned a per-event classification that describes a negative predictive event significance classification as the selected predictive event significance classification for the particular predictive event.

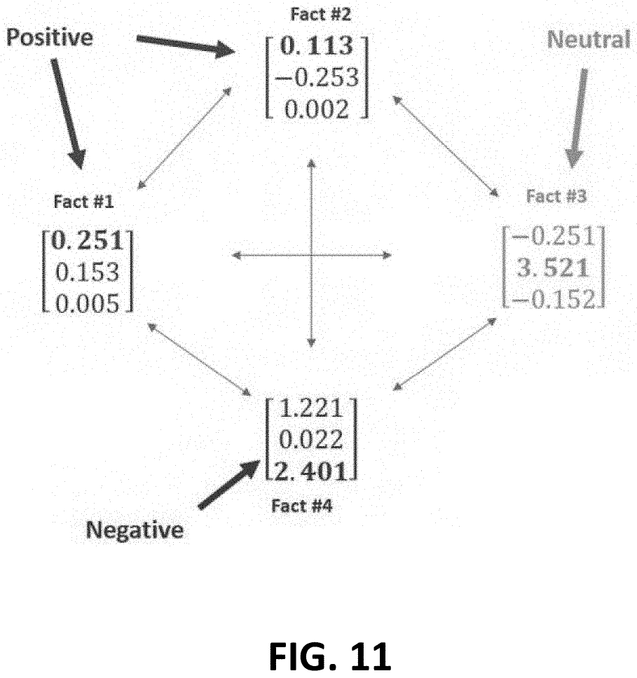

For example, as depicted in FIG. 11: (i) the first predictive event is assigned a per-event classification that describes a positive predictive event significance classification because the largest value of the final embedding for the first predictive event is the first value of the final embedding for the first predictive event, (ii) the second predictive event is assigned a per-event classification that describes a positive predictive event significance classification because the largest value of the final embedding for the second predictive event is the first value of the final embedding for the second predictive event, (iii) the third predictive event is assigned a per-event classification that describes a neutral predictive event significance classification because the largest value of the final embedding for the third predictive event is the second value of the final embedding for the third predictive event, and (iv) the fourth predictive event is assigned a per-event classification that describes a negative predictive event significance classification because the largest value of the final embedding for the fourth predictive event is the third value of the final embedding for the fourth predictive event.

In general, in some embodiments, for a particular classification scheme, C per-event classifications may be defined (e.g., two per-event classifications comprising an affirmative per-event classification and a negative per-event classification; three per-event classification comprising a per-event classification corresponding to a positive predictive event significance classification, a per-event classification corresponding to a negative predictive event significance classification, and a per-event classification corresponding to a neutral predictive event significance classification; and/or the like). Moreover, for each of the C per-event classifications, one or more satisfying patterns can be defined, where a particular per-event classification is assigned to a particular predictive event if at least one of the final predictive event embeddings for the particular predictive event or the final relationship event embeddings for the event relationship links that are associated with the particular predictive event satisfy conditions of at least one of the satisfying patterns associated with the particular per-event classification. For example, in an exemplary embodiment, a satisfying pattern may require that an affirmative per-event classification be assigned to a predictive event if both of the following conditions are satisfied: (i) the first value of the final predictive event embedding for the predictive event exceeds the third value of the final predictive event embedding, and (ii) no relationship embedding that is associated with the predictive event includes a negative value. As another example, in an exemplary embodiment, a satisfying pattern may require that a per-event classification corresponding to a positive predictive event significance classification be assigned to a predictive event if both of the following conditions are satisfied: (i) the second value of the final predictive event embedding for the predictive event exceeds the third value of the final predictive event embedding, and (ii) at least one relationship embedding associated with the predictive event satisfies the following condition: a first value of the relationship embedding exceeds the second value of the relationship embedding.

In some embodiments, the cross-event classification for a predictive entity may describe the per-event classification for at least one predictive event that is associated with the predictive entity. For example, in some embodiments, the cross-event classification for a predictive entity describes at least one of the following: (i) which predictive events of the predictive entity are associated with affirmative per-event classifications, or (ii) which predictive events of the predictive entity are associated with negative per-event classifications. As another example, in some embodiments, the cross-event classification for a predictive entity describes at least one of the following: (i) which predictive events of the predictive entity are associated with positive predictive event significance classifications, (ii) which predictive events of the predictive entity are associated with negative predictive event significance classifications, or (i) which predictive events of the predictive entity are associated with neutral predictive event significance classifications.

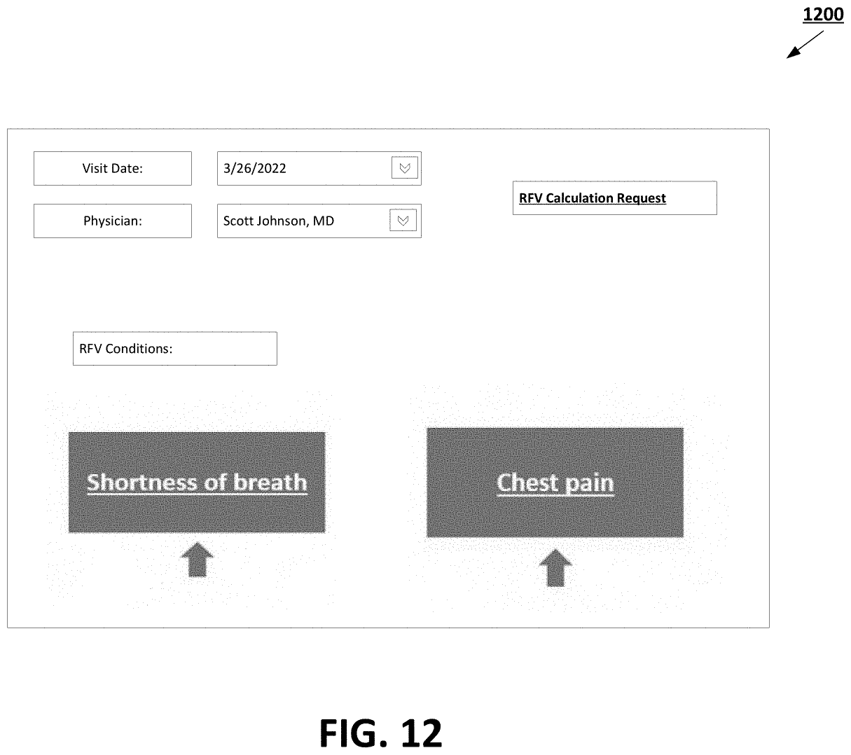

At step/operation 406, the predictive data analysis computing entity 106 performs one or more prediction-based actions based at least in part on the cross-event classification for the predictive entity. In some embodiments, performing the one or more prediction-based actions comprises performing one or more appointment scheduling operations, one or more automated investigation operations, and/or one or more automated audit operations based at least in part on the cross-event classification for the predictive entity. In some embodiments, performing the one or more prediction-based actions comprises generating user interface data for a prediction output user interface that describes at least a portion of the cross-event classification for a predictive entity. For example, as depicted in FIG. 12, the prediction output user interface 1200 describes medical conditions that are predicted to be parts of the RFV for a selected medical visit as well as medical conditions that are predicted to not be parts of the RFV for the selected medical visit.

In some embodiments, performing the one or more prediction-based actions comprises performing operational load balancing operations with respect to a post-prediction system that uses the predictive inference outputs generated by the predictive data analysis system 101 to perform post-processing operations. For example, in some embodiments, a predictive data analysis computing entity determines E per-event classifications for E predictive events of a predictive entity based at least in part on the event relationship network data object with the predictive entity. Then, the count of predictive events that are associated with affirmative per-event classifications, along with a resource utilization ratio for each predictive event, can be used to predict a predicted number of computing entities needed to perform post-prediction processing operations (e.g., automated reason for visit investigation operations) with respect to the E predictive events. For example, in some embodiments, the number of computing entities needed to perform post-prediction processing operations (e.g., automated investigation operations) with respect to the E predictive events can be determined based at least in part on the output of the equation: R=ceil(Σₖ^{k=K} urₖ), where R is the predicted number of computing entities needed to perform post-prediction processing operations with respect to the E predictive events, ceil(.) is a ceiling function that returns the closest integer that is greater than or equal to the value provided as the input parameter of the ceiling function, k is an index variable that iterates over K predictive events among the E predictive events that are associated with affirmative investigative classifications, and urₖ is the estimated resource utilization ratio for a kth predictive event that may be determined based at least in part on a size of input data associated with the kth predictive event. In some embodiments, once R is generated, the predictive data analysis computing entity can use R to perform operational load balancing for a server system that is configured to perform post-prediction processing operations (e.g., automated investigation operations) with respect to the E predictive events. This may be done by allocating computing entities to the post-prediction processing operations if the number of currently-allocated computing entities is below R, and deallocating currently-allocated computing entities if the number of currently-allocated computing entities is above R.

Accordingly, as described above, various embodiments of the present invention improve computational efficiency of generating cross-event classifications for predictive entities that are associated with a large number of predictive events by disclosing techniques that generate a cross-event predictive classification for a predictive entity via processing an event relationship network data object associated with the predictive entity using a set of sequential network updates associated with the layers of a network-based inference machine learning model. Given a predictive entity that is associated with E predictive events, a naïve solution to generating a cross-event classification for the predictive entity based at least in part on the E predictive events comprises processing each of the E predictive events using a trained classification machine learning model. If each inference of the trained classification machine learning model involves an average of F₁ floating point operations per second (FLOPS), because E inferences need to be performed in accordance with the naïve solution, then this means that generating a cross-event classification for the predictive entity based at least in part on the E predictive events associated with the predictive entity and in accordance with the naïve approach has a computational complexity of O(E*F₁). In contrast, various embodiments of the present invention generate an event relationship network data object that describes embeddings for all of the E predictive events and process the event relationship network data object using a singular predictive inference of a network-based inference machine learning model to generate the cross-event classification for the corresponding predictive entity. This means that, if each inference of the network-based inference machine learning model involves an average of F₂ FLOPS, because only a single inference of the network-based inference machine learning model is performed in accordance with various embodiments of the present invention, then this means that generating a cross-event classification for the predictive entity performed in accordance with various embodiments of the present invention has a computational complexity of O(F₂).

Moreover, because in at least some embodiments the operations of the network-based inference machine learning model comprise a sequence of linear combination operations (e.g., a sequence of matrix multiplication operations), it is expected that F₂=<F₁ (and most likely F₂<F₁), which means that, for E>1, O(F₂) is guaranteed to be less than O(E*F₁), and the performance gap between the two computational complexities increases as the value of E increases.

Accordingly, by reducing the computational complexity of generating a cross-event classification for a predictive entity that is associated with two or more predictive events, and by reducing the number of computer processor operations needed to generate a cross-event classification for a predictive entity that is associated with two or more predictive events, various embodiments of the present invention improve computational efficiency of generating cross-event classifications in relation to predictive entities that are associated with a large number of predictive events.

### VI. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A computer-implemented method for generating a cross-event classification for a predictive entity, the computer-implemented method comprising:
identifying, using one or more processors, a plurality of predictive events associated with the predictive entity;
for each predictive event, generating, using the one or more processors and an predictive event embedding machine learning model and based at least in part on the predictive event, a predictive event embedding for the predictive event;
generating, using the one or more processors, an event relationship network data object for the predictive entity, wherein the event relationship network data object describes: (i) a plurality of predictive event embeddings each associated with a respective predictive event, and (ii) one or more event relationship links each associated with an predictive event pair comprising a first predictive event and a second predictive event, and (iii) one or more relationship embeddings each associated with a respective event relationship link;
generating, using the one or more processors and a network-based inference machine learning model and based at least in part on the event relationship network data object: (i) a final predictive event embedding for each predictive event, and (ii) a final relationship embedding for each event relationship link, wherein:
the network-based inference machine learning model comprises L sequential network update layers,
each sequential network update layer is configured to update the event relationship network data object based at least in part on a trained parameter set associated with the sequential network update layer, and
each final predictive event embedding and each final relationship embedding is determined based at least in part on a final sequential network update layer as generated by the final sequential network update layer;
generating, using the one or more processors, the cross-event classification based at least in part on at least one of each final predictive event embedding and each final relationship embedding; and
performing, using the one or more processors, one or more prediction-based actions based at least in part on the cross-event classification.

2. The computer-implemented method of claim 1, wherein generating the cross-event classification comprises:
for each predictive event, generating a per-event classification based at least in part on the final predictive event embedding for the predictive event; and
generating the cross-event classification based at least in part on each per-event classification.

3. The computer-implemented method of claim 2, wherein generating the per-event classification for a particular predictive event comprises:
generating the per-event classification based at least in part on whether an ith value of the final predictive event embedding for the particular predictive event satisfies a threshold value defined based at least in part on a jth value of the final predictive event embedding for the particular predictive event.

4. The computer-implemented method of claim 2, wherein generating the per-event classification for a particular predictive event comprises:
determining a maximal value position indicator for a maximal value of the final predictive event embedding of the particular predictive event;
selecting, from a group of defined predictive event significance classifications, a selected predictive event significance classification for the particular predictive event based at least in part on the maximal value position indicator; and
generating the per-event classification based at least in part on the selected predictive event significance classification.

5. The computer-implemented method of claim 1, wherein:
the plurality of predictive events comprise E predictive events,
prior to L updates performed on the event relationship network data object by the L sequential network update layers: (i) each predictive event embedding comprises N₀ values, and (ii) the event relationship network data object comprises an E*N₀ event-related two-dimensional data object,
each ith sequential network update layer is configured to: (i) identify an E*Nᵢ₋₁ event-related two-dimensional data object associated with the event relationship network data object, and (ii) process the event relationship network data object to transform the E*Nᵢ₋₁ event-related two-dimensional data object to an E*Nᵢ event-related two-dimensional data object, and
the trained parameter set for each ith sequential network update layer comprises an Nᵢ₋₁*Nᵢ two-dimensional event-related parameter data object describing Nᵢ₋₁*Nᵢ event-related trained parameter values.

6. The computer-implemented method of claim 5, wherein:
the one or more event relationship links comprise R event relationship links,
prior to the L updates performed on the event relationship network data object by the L sequential network update layers: (i) each relationship embedding comprises K₀ values, and (ii) the event relationship network data object comprises an R*K₀ relationship-related two-dimensional data object,
each ith sequential network update layer is configured to: (i) identify an R*Kᵢ₋₁ relationship-related two-dimensional data object associated with the event relationship network data object, and (ii) process the event relationship network data object to transform the R*Kᵢ₋₁ relationship-related two-dimensional data object to an R*Kᵢ relationship-related two-dimensional data object, and
the trained parameter set for each ith sequential network update layer comprises an Kᵢ₋₁*Kᵢ two-dimensional relationship-related parameter data object describing Kᵢ₋₁*Kᵢ relationship-related trained parameter values.

7. The computer-implemented method of claim 6, wherein the R event relationship links comprise
$$\frac{E !}{2 ( E - 2 ) !}$$
event relationship links.

8. An apparatus for generating a cross-event classification for a predictive entity, the apparatus comprising at least one processor and at least one memory including program code, the at least one memory and the program code configured to, with the processor, cause the apparatus to at least:
identify a plurality of predictive events associated with the predictive entity;
for each predictive event, generate, using an predictive event embedding machine learning model and based at least in part on the predictive event, a predictive event embedding for the predictive event;
generate an event relationship network data object for the predictive entity, wherein the event relationship network data object describes: (i) a plurality of predictive event embeddings each associated with a respective predictive event, and (ii) one or more event relationship links each associated with an predictive event pair comprising a first predictive event and a second predictive event, and (iii) one or more relationship embeddings each associated with a respective event relationship link;
generate, using a network-based inference machine learning model and based at least in part on the event relationship network data object: (i) a final predictive event embedding for each predictive event, and (ii) a final relationship embedding for each event relationship link, wherein:
the network-based inference machine learning model comprises L sequential network update layers,
each sequential network update layer is configured to update the event relationship network data object based at least in part on a trained parameter set associated with the sequential network update layer, and
each final predictive event embedding and each final relationship embedding is determined based at least in part on a final sequential network update layer as generated by the final sequential network update layer;
generate the cross-event classification based at least in part on at least one of each final predictive event embedding and each final relationship embedding; and
perform one or more prediction-based actions based at least in part on the cross-event classification.

9. The apparatus of claim 8, wherein generating the cross-event classification comprises:
for each predictive event, generating a per-event classification based at least in part on the final predictive event embedding for the predictive event; and
generating the cross-event classification based at least in part on each per-event classification.

10. The apparatus of claim 9, wherein generating the per-event classification for a particular predictive event comprises:
generating the per-event classification based at least in part on whether an ith value of the final predictive event embedding for the particular predictive event satisfies a threshold value defined based at least in part on a jth value of the final predictive event embedding for the particular predictive event.

11. The apparatus of claim 9, wherein generating the per-event classification for a particular predictive event comprises:
determining a maximal value position indicator for a maximal value of the final predictive event embedding of the particular predictive event;
selecting, from a group of defined predictive event significance classifications, a selected predictive event significance classification for the particular predictive event based at least in part on the maximal value position indicator; and
generating the per-event classification based at least in part on the selected predictive event significance classification.

12. The apparatus of claim 8, wherein:
the plurality of predictive events comprise E predictive events,
prior to L updates performed on the event relationship network data object by the L sequential network update layers: (i) each predictive event embedding comprises N₀ values, and (ii) the event relationship network data object comprises an E*N₀ event-related two-dimensional data object,
each ith sequential network update layer is configured to: (i) identify an E*Nᵢ₋₁ event-related two-dimensional data object associated with the event relationship network data object, and (ii) process the event relationship network data object to transform the E*Nᵢ₋₁ event-related two-dimensional data object to an E*Nᵢ event-related two-dimensional data object, and
the trained parameter set for each ith sequential network update layer comprises an Nᵢ₋₁*Nᵢ two-dimensional event-related parameter data object describing Nᵢ₋₁*Nᵢ event-related trained parameter values.

13. The apparatus of claim 12, wherein:
the one or more event relationship links comprise R event relationship links,
prior to the L updates performed on the event relationship network data object by the L sequential network update layers: (i) each relationship embedding comprises K₀ values, and (ii) the event relationship network data object comprises an R*K₀ relationship-related two-dimensional data object,
each ith sequential network update layer is configured to: (i) identify an R*Kᵢ₋₁ relationship-related two-dimensional data object associated with the event relationship network data object, and (ii) process the event relationship network data object to transform the R*Kᵢ₋₁ relationship-related two-dimensional data object to an R*Kᵢ relationship-related two-dimensional data object, and
the trained parameter set for each ith sequential network update layer comprises an Kᵢ₋₁*Kᵢ two-dimensional relationship-related parameter data object describing Kᵢ₋₁*Kᵢ relationship-related trained parameter values.

14. The apparatus of claim 13, wherein the R event relationship links comprise
$$\frac{E !}{2 ( E - 2 ) !}$$
event relationship links.

15. A computer program product for generating a cross-event classification for a predictive entity, the computer program product comprising at least one non-transitory computer-readable storage medium having computer-readable program code portions stored therein, the computer-readable program code portions configured to:
identify a plurality of predictive events associated with the predictive entity;
for each predictive event, generate, using an predictive event embedding machine learning model and based at least in part on the predictive event, a predictive event embedding for the predictive event;
generate an event relationship network data object for the predictive entity, wherein the event relationship network data object describes: (i) a plurality of predictive event embeddings each associated with a respective predictive event, and (ii) one or more event relationship links each associated with an predictive event pair comprising a first predictive event and a second predictive event, and (iii) one or more relationship embeddings each associated with a respective event relationship link;
generate, using a network-based inference machine learning model and based at least in part on the event relationship network data object: (i) a final predictive event embedding for each predictive event, and (ii) a final relationship embedding for each event relationship link, wherein:
the network-based inference machine learning model comprises L sequential network update layers,
each sequential network update layer is configured to update the event relationship network data object based at least in part on a trained parameter set associated with the sequential network update layer, and
each final predictive event embedding and each final relationship embedding is determined based at least in part on a final sequential network update layer as generated by the final sequential network update layer;
generate the cross-event classification based at least in part on at least one of each final predictive event embedding and each final relationship embedding; and
perform one or more prediction-based actions based at least in part on the cross-event classification.

16. The computer program product of claim 15, wherein generating the cross-event classification comprises:
for each predictive event, generating a per-event classification based at least in part on the final predictive event embedding for the predictive event; and
generating the cross-event classification based at least in part on each per-event classification.

17. The computer program product of claim 16, wherein generating the per-event classification for a particular predictive event comprises:
generating the per-event classification based at least in part on whether an ith value of the final predictive event embedding for the particular predictive event satisfies a threshold value defined based at least in part on a jth value of the final predictive event embedding for the particular predictive event.

18. The computer program product of claim 16, wherein generating the per-event classification for a particular predictive event comprises:
determining a maximal value position indicator for a maximal value of the final predictive event embedding of the particular predictive event;
selecting, from a group of defined predictive event significance classifications, a selected predictive event significance classification for the particular predictive event based at least in part on the maximal value position indicator; and
generating the per-event classification based at least in part on the selected predictive event significance classification.

19. The computer program product of claim 15, wherein:
the plurality of predictive events comprise E predictive events,
prior to L updates performed on the event relationship network data object by the L sequential network update layers: (i) each predictive event embedding comprises N₀ values, and (ii) the event relationship network data object comprises an E*N₀ event-related two-dimensional data object,
each ith sequential network update layer is configured to: (i) identify an E*Nᵢ₋₁ event-related two-dimensional data object associated with the event relationship network data object, and (ii) process the event relationship network data object to transform the E*Nᵢ₋₁ event-related two-dimensional data object to an E*Nᵢ event-related two-dimensional data object, and
the trained parameter set for each ith sequential network update layer comprises an Nᵢ₋₁*Nᵢ two-dimensional event-related parameter data object describing Nᵢ₋₁*Nᵢ event-related trained parameter values.

20. The computer program product of claim 19, wherein:
the one or more event relationship links comprise R event relationship links,
prior to the L updates performed on the event relationship network data object by the L sequential network update layers: (i) each relationship embedding comprises K₀ values, and (ii) the event relationship network data object comprises an R*K₀ relationship-related two-dimensional data object,
each ith sequential network update layer is configured to: (i) identify an R*Kᵢ₋₁ relationship-related two-dimensional data object associated with the event relationship network data object, and (ii) process the event relationship network data object to transform the R*Kᵢ₋₁ relationship-related two-dimensional data object to an R*Kᵢ relationship-related two-dimensional data object, and
the trained parameter set for each ith sequential network update layer comprises an Kᵢ₋₁*Kᵢ two-dimensional relationship-related parameter data object describing Kᵢ₋₁*Kᵢ relationship-related trained parameter values.
